(19) United States
(12) Patent Application Publication
(10) Pub. No.: US 2025/0326003 A1
(43) Pub. Date: Oct. 23, 2025

(54) TRANSDUCER

(71) Applicant: CANON KABUSHIKI KAISHA, Tokyo (JP)

(72) Inventors: MASAHIRO WATANABE, Shizuoka (JP); TETSUO HINO, Kanagawa (JP); RYO OGAWA, Kanagawa (JP); TAKAYUKI HIRATANI, Tokyo (JP)

(21) Appl. No.: 19/096,159

(22) Filed: Mar. 31, 2025

(30) Foreign Application Priority Data
Apr. 23, 2024 (JP) 2024-069689
Dec. 10, 2024 (JP) 2024-215076

(51) Int. Cl. B06B 1/02

(52) U.S. Cl. CPC B06B 1/0292

(57) ABSTRACT

A transducer, the transducer includes a dielectric layer, in which the dielectric layer has a relative dielectric constant of 8.0 or more at a frequency of 1 kHz, and the dielectric layer includes a urethane elastomer, a structure of a cyclic multidentate ligand, an anionic structure, and a cationic structure.

### BACKGROUND OF THE INVENTION

### Field of the Invention

The present disclosure relates to a transducer.

### Description of the Related Art

A transducer including a dielectric layer and at least two electrodes holding the dielectric layer therebetween has been applied in various fields as an element that mutually converts electrical energy and mechanical energy with high conversion efficiency utilizing deformation (expansion and contraction) of the dielectric layer. For example, when electrical energy generated by the deformation of the dielectric layer due to an external force is obtained as an output, application as a sensor or a power generating element is possible. Further, a difference in potential is applied between the pair of electrodes to generate stress in the dielectric layer, which makes it possible to function as an actuator.

When the dielectric layer is used in such sensor applications, actuator applications, and power generation applications, it is preferable that the dielectric layer has a high dielectric constant from the viewpoint of increasing conversion efficiency, and has flexibility from the viewpoint of ease of deformation.

For example, WO 2013/058237 discloses a transducer using an elastomer including barium titanate particles as a dielectric layer.

In addition, Japanese Patent Application Publication No. 2019-124506 discloses a capacitance-type sensor using urethane foam as a dielectric layer.

### SUMMARY OF THE INVENTION

However, although the dielectric layer according to WO 2013/058237 uses a flexible elastomer, the elastic modulus of the dielectric layer is high because it contains a large amount of barium titanate to increase the relative dielectric constant. Meanwhile, although the dielectric layer according to Japanese Patent Application Publication No. 2019-124506 is formed of only flexible urethane foam, the urethane foam has a low relative dielectric constant and is a thin film having a thickness of not more than 1 mm in order to improve the sensitivity of the sensor.

As described above, it has been difficult to achieve various characteristics required when using a dielectric layer as a transducer. At least one aspect of the present disclosure is directed to a transducer capable of converting from mechanical energy to electrical energy and/or from mechanical energy to electrical energy, the transducer including a dielectric layer having a high dielectric constant and high flexibility.

At least one aspect of the present disclosure is a transducer capable of converting from mechanical energy to electrical energy and/or from electrical energy to mechanical energy,
the transducer comprising a dielectric layer,
wherein a relative dielectric constant of the dielectric layer at a frequency of 1 kHz is at least 8.0, and
the dielectric layer satisfies any of conditions (i) to (vi) below:
(i) the dielectric layer comprises a urethane elastomer, an ionic liquid, and a cyclic multidentate ligand;
(ii) the dielectric layer comprises a urethane elastomer, a cyclic multidentate ligand, and an anion, and the urethane elastomer has a cationic structure in a molecule;
(iii) the dielectric layer comprises a urethane elastomer, a cyclic multidentate ligand, and a cation, and the urethane elastomer has an anionic structure in a molecule;
(iv) the dielectric layer comprises a urethane elastomer and an ionic liquid, and the urethane elastomer has a structure of a cyclic multidentate ligand in a molecule;
(v) the dielectric layer comprises a urethane elastomer and an anion, and the urethane elastomer has a structure of a cyclic multidentate ligand and a cationic structure in a molecule; and
(vi) the dielectric layer comprises a urethane elastomer and a cation, and the urethane elastomer comprises a structure of a cyclic multidentate ligand and an anionic structure in a molecule.

At least one aspect of the present disclosure provides a transducer capable of converting from mechanical energy to electrical energy and/or from mechanical energy to electrical energy, the transducer including a dielectric layer having a high dielectric constant and high flexibility.

Further features of the present invention will become apparent from the following description of exemplary embodiments with reference to the attached drawings.

### BRIEF DESCRIPTION OF THE DRAWINGS

FIGS. 1A to 1C are schematic diagrams showing a mechanism of increasing the relative dielectric constant of a dielectric layer according to the present disclosure;

FIG. 2 is a schematic diagram showing a method of producing a dielectric layer according to the present disclosure; and

FIG. 3 is a schematic diagram of a transducer according to an embodiment of the present disclosure.

### DESCRIPTION OF THE EMBODIMENTS

In the present disclosure, “from XX to YY” or “XX to YY” indicating a numerical range means a numerical range including a lower limit and an upper limit that are end points unless otherwise specified. In a case where numerical ranges are described in stages, an upper limit and a lower limit of each numerical range can be combined as desired. Furthermore, in the present disclosure, for example, description such as “at least one selected from the group consisting of XX, YY, and ZZ” means any of XX, YY, ZZ, a combination of XX and YY, a combination of XX and ZZ, a combination of YY and ZZ, or a combination of XX, YY, and ZZ.

Hereinafter, embodiments of the present disclosure will be described. Note that the embodiments described below are merely examples, and the present disclosure is not limited to these embodiments.

### Dielectric Layer

In at least one aspect of the present disclosure, the dielectric layer satisfies any of conditions (i) to (vi) below:
(i) the dielectric layer includes a urethane elastomer, an ionic liquid, and a cyclic multidentate ligand;
(ii) the dielectric layer includes a urethane elastomer, a cyclic multidentate ligand, and an anion, and the urethane elastomer has a cationic structure in a molecule;
(iii) the dielectric layer includes a urethane elastomer, a cyclic multidentate ligand, and a cation, and the urethane elastomer has an anionic structure in a molecule;
(iv) the dielectric layer includes a urethane elastomer and an ionic liquid, and the urethane elastomer has a structure of a cyclic multidentate ligand in a molecule;
(v) the dielectric layer includes a urethane elastomer and an anion, and the urethane elastomer has a structure of a cyclic multidentate ligand and a cationic structure in a molecule; and
(vi) the dielectric layer includes a urethane elastomer and a cation, and the urethane elastomer has a structure of a cyclic multidentate ligand and an anionic structure in a molecule.

First, the condition (i) in which the dielectric layer includes a urethane elastomer, an ionic liquid, a cyclic multidentate ligand will be described.

The present inventors have found that a dielectric layer including a urethane elastomer, an ionic liquid, and a cyclic multidentate ligand can exhibit a high relative dielectric constant. The present inventors consider that the expression mechanism is as follows.

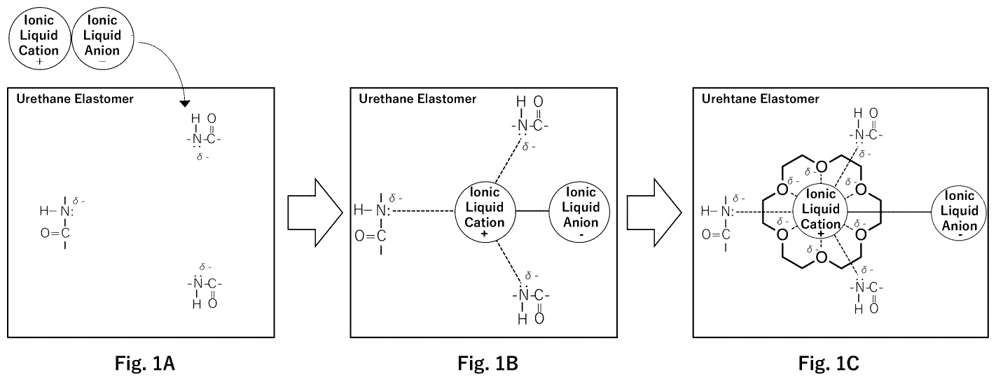

It is considered that an increase in relative dielectric constant in the present disclosure is induced by the fact that the distance between cation and anion pairs of the ionic liquid is increased and the ionic polarization progresses. The mechanism of increasing the relative dielectric constant of the dielectric layer will be described with reference to FIGS. 1A to 1C. In FIGS. 1A to 1C, examples of 18-crown 6-ether are listed as cyclic multidentate ligands.

The urethane elastomer contains an ionic liquid (FIG. 1A), as a result of which nitrogen derived from a urethane bond in the urethane elastomer electrically interacts with the cation of the ionic liquid at the lone electron pair of the nitrogen, thereby reducing the molecular mobility of the ionic liquid (FIG. 1). The reduction in molecular mobility of the ionic liquid makes it easier for a cyclic multidentate ligand having high coordination ability to a cation to coordinate to the cation of the ionic liquid.

The cyclic multidentate ligand coordinates to the cation of the ionic liquid to form a complex, as a result of which the distance between cation and anion pairs of the ionic liquid is increased (FIG. 1C), and the ionic polarization of the ionic liquid increases, thereby inducing an increase in relative dielectric constant.

For this reason, for example, even when an ionic liquid and a cyclic multidentate ligand are blended in a silicone rubber not containing a urethane bond instead of a urethane elastomer, it is not possible to allow the cyclic multidentate ligand to coordinate to the cation of the ionic liquid effectively due to high molecular mobility of the ionic liquid, and the relative dielectric constant is not increased.

In addition, it is considered that the complex is formed, the distance between the ion pairs is increased, and the ionic polarization is increased, thereby increasing the relative dielectric constant. Accordingly, the relative dielectric constant is increased and the effect of flexibility is obtained not only in the case where the dielectric layer includes the ionic liquid. For example, the urethane elastomer may have a cationic structure or an anionic structure in a molecule.

That is, there may be an aspect in which (ii) the dielectric layer includes a urethane elastomer, a cyclic multidentate ligand, and an anion, and the urethane elastomer has a cationic structure in a molecule. In this case, the cyclic multidentate ligand may coordinate to the cationic structure in the molecule.

Also, there may be an aspect in which (iii) the dielectric layer includes a urethane elastomer, a cyclic multidentate ligand, a cation, and the urethane elastomer has an anionic structure in a molecule. In this case, in addition to the urethane bond, the molecular mobility of the cation decreases due to the influence of the anionic structure, and the cyclic multidentate ligand may be coordinated.

Similarly, the urethane elastomer may have a cyclic multidentate ligand in the molecule from the viewpoint of improving the relative dielectric constant and achieving the effect of flexibility. That is, there may be an aspect in which (iv) the dielectric layer includes a urethane elastomer and an ionic liquid, and the urethane elastomer has a cyclic multidentate ligand in a molecule. In this case, it is also considered that the molecular mobility of the ionic liquid is reduced by the urethane bond, and the cyclic multidentate ligand in the molecule of the urethane elastomer is coordinated to the cation of the ionic liquid, and thus the above effect is obtained.

Furthermore, for example, there is mentioned an aspect in which the dielectric layer includes a urethane elastomer and one of ions selected from the group consisting of an anion and a cation, and the urethane elastomer has a cyclic multidentate ligand and an ionic structure having a polarity opposite to the polarity of the ion in the molecule. It is also considered that the above effects by the complex are obtained in this aspect.

More specifically, the following conditions (v) and (vi) are mentioned:
(v) the dielectric layer includes a urethane elastomer and an anion, and the urethane elastomer has a structure of a cyclic multidentate ligand and a cationic structure in a molecule; and
(vi) the dielectric layer includes a urethane elastomer and a cation, and the urethane elastomer has a structure of a cyclic multidentate ligand and an anionic structure in a molecule.

### Urethane Elastomer

The urethane elastomer is prepared mainly from polyol, polyisocyanate, a curing catalyst, a chain extender, other additives, and the like.

The polyol is not particularly limited as long as it has two or more hydroxyl groups in the molecule. The polyol is, for example, at least one selected from the group consisting of polyester polyol, polycarbonate polyol, polyether polyol, polycaprolactone polyol, polyolefin polyol, acrylic polyol, and the like.

Among these polyols, polycarbonate polyol and polyester polyol are preferred to be used as the transducer because the polycarbonate urethane and polyester urethane prepared by a reaction with polyisocyanate have characteristics excellent in mechanical strength, wear resistance and dielectric breakdown resistance. The polyol preferably includes at least one selected from the group consisting of polycarbonate polyol and polyester polyol. The urethane elastomer preferably contains at least one selected from the group consisting of polycarbonate urethane and polyester urethane.

The proportion of the structure corresponding to the polyol in the urethane elastomer is preferably 60 to 90% by mass, and 70 to 90% by mass.

Examples of the polycarbonate polyol include polycarbonate polyols prepared by condensation reaction of a diol component (such as 1,3-propanediol, 1,4-butanediol, 1,6-hexanediol, 1,8-octanediol, 1,9-nonanediol, 3-methyl-1,5-pentanediol, diethylene glycol, 2-methyl-1,8-octanediol, polyethylene glycol, polypropylene glycol or polytetramethylene glycol) with a dialkyl carbonate (such as phosgene or dimethyl carbonate) or a cyclic carbonate (such as ethylene carbonate). These polycarbonate polyols may be used singly, or in combination of two or more kinds thereof.

Examples of the polyester polyol include polyester polyols prepared by condensation reaction of a diol component (such as 1,4-butanediol, 1,5-pentanediol, neopentyl glycol, 3-methyl-1,5-pentanediol, 1,6-hexanediol, 1,8-octanediol or 1,9-nonanediol) or a triol component (such as trimethylolpropane) with a dicarboxylic acid (such as adipic acid, suberic acid, sebacic acid, phthalic anhydride, terephthalic acid or hexahydroxyphthalic acid). These polyester polyols may be used singly, or in combination of two or more kinds thereof.

The polyisocyanate to be reacted with the polyol is not particularly limited. For example, it is possible to use at least one selected from the group consisting of bifunctional isocyanate (diisocyanate) having two isocyanate groups, such as pentamethylene diisocyanate, hexamethylene diisocyanate, isophorone diisocyanate, 2,4-tolylene diisocyanate, 2,6-tolylene diisocyanate, xylylene diisocyanate or diphenylmethane diisocyanate, and polyisocyanate having at least three isocyanate groups, such as a trimer compounds of pentamethylene diisocyanate, a trimer compound of hexamethylene diisocyanate, and a multimer compound of diphenylmethane diisocyanate (polymeric MDI).

As the polyisocyanate, a bifunctional isocyanate having two isocyanate groups, such as xylylene diisocyanate, and a polyisocyanate having at least three isocyanate groups, such as polymeric MDI, are preferably used in combination. That is, the polyisocyanate preferably contains a bifunctional isocyanate and a polyisocyanate having at least three isocyanate groups. The combination described above can control the crosslinking density, and thus this is preferred from the viewpoint of flexibility.

The proportion of the structure corresponding to the bifunctional isocyanate in the urethane elastomer is preferably to 2 to 10% by mass, and 3 to 8% by mass.

The proportion of the structure corresponding to the polyisocyanate having at least three isocyanate groups in the urethane elastomer is preferably 3 to 15% by mass, and 4 to 8% by mass.

The curing catalyst for the urethane elastomer is, for example, a urethanization catalyst for promoting elastomerization (resinization) or an isocyanuration catalyst, and in the present disclosure, one of the catalysts may be used singly, or the catalysts may be mixed for use.

Examples of the urethanization catalyst include: tin-based urethanization catalysts, such as dibutyltin dilaurate and stannous octoate; and amine-based urethanization catalysts, such as triethylenediamine, tetramethylguanidine, pentamethyldiethylenetriamine, diethylimidazole, tetramethylpropanediamine, N,N,N′-trimethylaminoethylethanolamine, and 1,4-diazabicyclo[2.2.2]octane-2-methanol. One of these catalysts may be used singly, or the catalysts may be mixed for use. Among these urethanization catalysts, triethylenediamine and 1,4-diazabicyclo[2.2.2]octane-2-methanol is preferred from the viewpoint of particularly promoting the urethane reaction.

Examples of the isocyanuration catalyst include: metal oxides such as Li₂O, (Bu₃Sn)₂O; hydride compounds such as NaBH₄; alkoxide compounds such as NaOCH₃, KO-(t-Bu), and boric acid salt; amine compounds such as N(C₂H₅)₃, N(CH₃)₂CH₂C₂H₅, and 1,4-ethylene piperazine (DABCO); alkaline carboxylate salt compounds such as HCOONa, Na₂CO₃, PhCOONa/DMF, CH₃COOK, (CH₃COO)₂Ca, alkaline soap, and naphthenic acid salt; alkaline formic acid salt compounds; and quaternary ammonium salt compounds such as ((R)₃—NR′OH)—OCOR″. One of these compounds may be used singly, or the catalysts may be mixed for use.

In addition, N,N,N′-trimethylaminoethylethanolamine which independently acts as a urethanization catalyst and also exhibits an action of an isocyanuration catalyst may be used.

If necessary, a chain extender (polyfunctional low molecular weight polyol) may be used. Examples of the chain extender include glycols having a number average molecular weight of not more than 1000.

Examples of glycols include ethylene glycol (EG), diethylene glycol (DEG), propylene glycol (PG), dipropylene glycol (DPG), 1,4-butanediol (1,4-BD), 1,6-hexanediol (1,6-HD), 1,4-cyclohexanediol, 1,4-cyclohexanedimethanol, xylylene glycol (terephthalyl alcohol), and triethylene glycol.

Examples of chain extenders other than glycols include tri- or higher valent polyhydric alcohols. Examples of the tri- or higher valent polyhydric alcohols include trimethylolpropane, glycerin, pentaerythritol, and sorbitol. These alcohols may be used singly or mixed in combination.

If necessary, additives such as a conductive agent, a pigment, a plasticizer, a waterproof agent, an antioxidant, an ultraviolet absorber, and a light stabilizer may be used in combination.

### Ionic Liquid

The ionic liquid is a liquid including a cation and an anion, and is a salt that exists as a liquid in a wide temperature range. The salt is, for example, a salt having a melting point of not more than 100° C. due to use of a relatively large organic ion as an ionic species forming the salt. The ionic liquid plays a role of enhancing the dielectric properties of the dielectric layer.

The cation is not particularly limited, and examples of the cation include at least one selected from the group consisting of an imidazolium ion, a pyridinium ion, a pyrrolidinium ion, an ammonium ion, a piperidinium ion, a phosphonium ion, and the like. Among these ions, at least one selected from the group consisting of an ammonium ion and an imidazolium ion is preferred. That is, the ionic liquid is preferably at least one ionic liquid selected from the group consisting of an ammonium-based ionic liquid and an imidazolium-based ionic liquid.

Further, the cation is preferably an imidazolium ion. As described above, lone electron pairs derived from the urethane elastomer or the cyclic multidentate ligand stabilize the cations of the ionic liquid, and thus the distance between cation and anion pairs of the ionic liquid is increased, resulting in high dielectric properties. From this viewpoint, the coulomb interaction of the imidazolium ions with the anions is relatively weak as compared with other cation skeletons, and thus the distance between cation and anion pairs of the ionic liquid is likely to be increased, and it is possible to expect a highly enhanced dielectric constant.

Examples of the imidazolium ion include at least one selected from the group consisting of 1-ethyl-3-methylimidazolium, 1-butyl-3-methylimidazolium, 1-ethyl-2,3-dimethylimidazolium, 1-butyl-2,3-dimethylimidazolium, 1-hexyl-2,3-dimethylimidazolium, 1,3-bis(2-hydroxyethyl)imidazolium, 1-(2-hydroxyethyl)-3-methylimidazolium, 1-(3-hydroxypropyl)-3-methylimidazolium, 1-butyl-3-(2-hydroxyethyl)imidazolium, 1-ethyl-3-(2-hydroxyethyl)imidazolium, and the like.

Examples of the ammonium ion include at least one selected from the group consisting of quaternary ammonium salts such as methyltri-N-octylammonium, N-trimethyl-N-propylammonium, N-trimethyl-N-butylammonium, bis(2-hydroxyethyl)-methyl-octylammonium, bis(2-hydroxyethyl)-methyl-decylammonium, N,N-diethyl-N-methyl-N-(2-methoxyethyl)ammonium, and N,N-(2-hydroxyethyl)-N-(9-octadecene)-N-methylammonium.

The anion is not particularly limited. Examples of the anion include at least one selected from the group consisting of hydrogen sulfate anion (HSO₄⁻), a halogen ion, BF₄⁻, PF⁻, CF₃SO₃⁻, (CF₃SO₂)₂N⁻, (FSO₂)₂N⁻, and the like. From the viewpoint of enhancing the dielectric properties, it is preferable that the interaction between the cation and the anion is not high. Therefore, at least one selected from the group consisting of hydrogen sulfate anion (HSO₄⁻), BF₄⁻, PF₆⁻, CF₃SO₃⁻, (CF₃SO₂)₂N⁻, (FSO₂)₂N⁻, which are anions having a large molecular volume, is particularly preferred. The anion is more preferably at least one anion selected from the group consisting of hydrogen sulfate anion (HSO₄⁻), BF₄⁻, PF₆⁻, CF₃SO₃⁻, and (CF₃SO₂)₂N⁻.

Further, the ionic liquid can have a reactive functional group that reacts with an isocyanate group in a cation or an anion. The reactive functional group that reacts with the isocyanate group is, for example, a hydroxyl group. The presence of the reactive functional group achieves an aspect in which the urethane elastomer described above has a cationic structure or an anionic structure in the molecule. The ionic liquid has the reactive functional group that reacts with the isocyanate group, as a result of which the ionic liquid reacts with the polyisocyanate, and the cationic structure or the anionic structure is incorporated into the molecule of the urethane elastomer. Incorporating the cationic structure or the anionic structure into the molecule of the urethane elastomer makes it possible to prevent the ionic liquid from bleeding out over time.

Specific examples of the ionic liquid that can be suitably used in the present disclosure include at least one selected from the group consisting of 1-ethyl-3-methylimidazolium bis(trifluoromethanesulfonyl)imide, 1-butyl-3-methylimidazolium bis(trifluoromethanesulfonyl)imide, 1-hexyl-3-methylimidazolium bis(trifluoromethanesulfonyl)imide, 1-ethyl-2,3-dimethylimidazolium bis(trifluoromethanesulfonyl)imide, 1-butyl-2,3-dimethylimidazolium bis(trifluoromethanesulfonyl)imide, 1-hexyl-2,3-dimethylimidazolium bis(trifluoromethanesulfonyl)imide, 1,3-bis(2-hydroxyethyl)imidazolium bis(trifluoromethanesulfonyl)imide, 1-(2-hydroxyethyl)-3-methylimidazolium bis(trifluoromethanesulfonyl)imide, 1-(3-hydroxypropyl)-3-methylimidazolium bis(trifluoromethanesulfonyl)imide, 1-ethyl-1-methylpyrrolidinium bis(trifluoromethanesulfonyl)imide, 1-methyl-1-propylpyrrolidinium bis(trifluoromethanesulfonyl)imide, 1-butyl-1-methylpyrrolidinium bis(trifluoromethanesulfonyl)imide, 1-ethylpyridinium bis(trifluoromethanesulfonyl)imide, 1-propylpyridinium bis(trifluoromethanesulfonyl)imide, 1-methyl-1-propylpiperidinium bis(trifluoromethanesulfonyl)imide, 1-butyl-1-methylpiperidinium bis(trifluoromethanesulfonyl)imide, N-trimethyl-N-propylammonium bis(trifluoromethanesulfonyl)imide, N-trimethyl-N-butylammonium bis(trifluoromethanesulfonyl)imide, bis(2-hydroxyethyl)-methyl-octylammonium bis(trifluoromethanesulfonyl)imide, bis(2-hydroxyethyl)-methyl-decylammonium bis(trifluoromethanesulfonyl)imide, N,N-diethyl-N-methyl-N-(2-methoxyethyl)ammonium bis(trifluoromethanesulfonyl)imide, and N,N-(2-hydroxyethyl)-N-(9-octadecene)-N-methylammonium bis(trifluoromethanesulfonyl)imide.

Examples of commercially available products of the ionic liquid include, but are not particularly limited to, “ELEXCEL AS-110”, “ELEXCEL MP-442”, “ELEXCEL IL-210”, “ELEXCEL MP-471”, “ELEXCEL MP-456”, and “ELEXCEL AS-804” (manufactured by DKS Co., Ltd.), “HMI-FSI” (manufactured by Mitsubishi Materials Corporation), “CIL-312”, “CIL-542”, and “CIL-612” (manufactured by Japan Carlit Co., Ltd.), and IL-P series, IL-A series, IL-C series, IL-IM series, IL-AP series, and IL-OH series (manufactured by Koei Chemical Co., Ltd.).

The content of the ionic liquid in the dielectric layer is preferably 0.5 to 8.0% by mass based on the mass of the dielectric layer excluding the cyclic multidentate ligand. The content of the ionic liquid is more preferably 1.7 to 8.0% by mass, even more preferably 2.0 to 8.0% by mass, and yet even more preferably 2.0 to 4.0% by mass. When the content of the ionic liquid is at least 0.5% by mass, a higher level of dielectric constant can be expected as compared with a case where the content is less than 0.5% by mass. Further, the content of the ionic liquid is not more than 8.0% by mass, and thus the effect of the content on the dielectric constant increase is efficiently achieved.

Furthermore, the content of ionic liquid in the dielectric layer is preferably 0.5 to 7.0% by mass, more preferably 1.5 to 7.0% by mass, even more preferably 1.5 to 5.0% by mass, and yet even more preferably 1.6 to 4.0% by mass, based on the mass of the dielectric layer.

### Cyclic Multidentate Ligand

The cyclic multidentate ligand is a cyclic compound having a plurality of lone electron pairs in one molecule and capable of forming a complex by coordinate-bonding with a cation of an ionic liquid at two or more positions. The cyclic multidentate ligand is not particularly limited. Examples of the cyclic multidentate ligand include crown ethers, calixarenes, porphyrins, derivatives thereof, and modified products thereof. These substances may be used singly, or in combination of two or more kinds thereof. Examples of the cyclic multidentate ligand include at least one selected from the group consisting of a crown ether compound, a calixarene compound, and a porphyrin compound.

The crown ether compound preferably has a structure represented by Formula (2). That is, the cyclic multidentate ligand preferably has a structure represented by Formula (2).

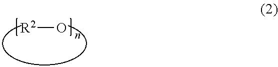

In Formula (2), n is an integer of 4 to 8, and R² represents an ethylene group or a phenylene group which may have a substituent, preferably an ethylene group. Examples of the substituent include at least one selected from the group consisting of a hydroxymethyl group, a hydroxyethyl group, an aminomethyl group, an amino group, and a carboxy group. The substituent is preferably a hydroxymethyl group.

Specific examples of the crown ether compound that can be suitably used in the present disclosure include at least one selected from the group consisting of 12-crown 4-ether, 15-crown 5-ether, 18-crown 6-ether, 21-crown 7-ether, 24-crown 8 ether, benzo-12-crown 4-ether, benzo-15-crown 5-ether, benzo-18-crown 6-ether, benzo-21-crown 7-ether, benzo-24-crown 8-ether, dibenzo-12-crown 4-ether, dibenzo-15-crown 5-ether, dibenzo-18-crown 6-ether, dibenzo-21-crown 7-ether, dibenzo-24-crown 8-ether, 2-hydroxymethyl-12-crown 4-ether, 2-hydroxymethyl-18-crown 6-ether, 2-hydroxyethyl-18-crown 6-ether, 2-aminomethyl-15-crown 5-ether, 4′-aminobenzo-15-crown 5-ether, 4′-aminobenzo-18-crown 6-ether, 4′-carboxybenzo-15-crown 5-ether, and 4′-carboxybenzo-18-crown 6-ether.

The calixarene compound preferably has a structure represented by Formula (3). That is, the cyclic multidentate ligand preferably has a structure represented by Formula (3).

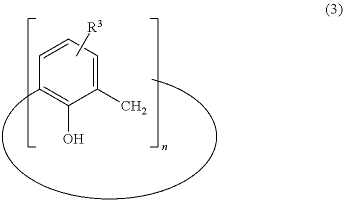

In Formula (3), n is an integer of 4 to 6, and R³ represents a hydrogen atom or an arbitrary organic group. Examples of the organic group include —SO₃H and a C1-C8 (preferably C1-C4) alkyl group. Specific examples of the calixarene compound that can be suitably used in the present disclosure include at least one selected from the group consisting of calix[4]arene, calix[5]arene, calix[6]arene, 4-t-butylcalix[4]arene, 4-t-butylcalix[5]arene, 4-t-butylcalix[6]arene, 4-sulfocalix[4]arene, 4-sulfocalix[5]arene, and 4-sulfocalix[6]arene.

The porphyrin compound has a structure represented by Formula (4).

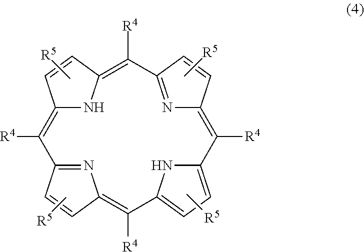

In Formula (4), R⁴ and R⁵ each independently represent a hydrogen atom or any organic group. The organic group is, for example, a C1-C8 alkyl group or a phenyl group. Preferably, the organic group is a phenyl group. It is preferable that R⁵ is a hydrogen atom and R⁴ is a phenyl group. That is, the porphyrin compound is preferably tetraphenylporphyrin.

Furthermore, among the cyclic multidentate ligands exemplified above, a cyclic multidentate ligand having a reactive functional group that reacts with an isocyanate group may be used. The presence of such a reactive functional group achieves an aspect in which the urethane elastomer has a cyclic multidentate ligand in the molecule. A cyclic multidentate ligand having a reactive functional group that reacts with an isocyanate group reacts with the polyisocyanate, and the cyclic multidentate ligand is incorporated into the molecule of the urethane elastomer. Incorporating the cyclic multidentate ligand into the molecule of the urethane elastomer makes it possible to prevent the cyclic multidentate ligand from bleeding out over time. The reactive functional group that reacts with the isocyanate group is, for example, a hydroxyl group.

In addition, an ionic liquid having a reactive functional group that reacts with an isocyanate group in a cation or an anion, and a cyclic multidentate ligand having a reactive functional group that reacts with an isocyanate group may be used. The use of ionic liquid and the cyclic multidentate ligand achieves an aspect in which an aspect in which the dielectric layer includes a urethane elastomer and one of ions selected from the group consisting of an anion and a cation, and the urethane elastomer has a cyclic multidentate ligand and an ionic structure having a polarity opposite to the polarity of the ion in the molecule.

The content of the cyclic multidentate ligand in the dielectric layer is preferably 1.0 to 8.0-fold mol relative to the number of moles of the ionic liquid. More preferably, the content is 2.0 to 4.0-fold mol. When the content of the cyclic multidentate ligand is at least 1.0-fold mol, a higher level of dielectric constant can be expected as compared with a case where the content is less than 1.0-fold mol. Further, the content of the cyclic multidentate ligand is not more than 8.0-fold mol, and thus the effect of the content on the dielectric constant increase is efficiently achieved.

### Relative Dielectric Constant

The relative dielectric constant of the dielectric layer is at least 8.0. The relative dielectric constant of the dielectric layer is preferably at least 10.0, more preferably at least 20.0. Here, the relative dielectric constant in the present disclosure is a relative dielectric constant observed when an AC voltage with a frequency of 1 kHz is applied at room temperature. The upper limit of the relative dielectric constant is not particularly limited. When the relative dielectric constant is within the range, the dielectric layer can be more suitably used as a dielectric layer for a transducer having excellent conversion efficiency of electrical energy and mechanical energy. The relative dielectric constant is preferably as high as possible, and the upper limit of the relative dielectric constant is not particularly limited. The relative dielectric constant of the dielectric layer is preferably 8.0 to 100.0, more preferably 10.0 to 100.0, and even more preferably 20.0 to 100.0.

The reason for the relative dielectric constant at a frequency of 1 kHz is that, as described above, the urethane elastomer or the cyclic multidentate ligand electrically traps the cation of the ionic liquid, thereby increasing the distance between the ion pairs of the ionic liquid and increasing the ionic polarization. This is because the magnitude of the ionic polarization is likely to appear as the relative dielectric constant at a frequency of 1 kHz.

A voltage is applied with the dielectric layer sandwiched between two electrodes of at least Φ1 mm. On the basis of the measured impedance, the relative dielectric constant can be calculated. First, a 4-terminal sample holder (SH2-Z type, manufactured by TOYO Corporation), an impedance analyzer (1260 A, manufactured by Solartron), and a dielectric interface (1296 A, manufactured by Solartron) are connected. Next, the dielectric layer is placed on a Φ10 mm lower electrode with a guard electrode so as to cover the entire electrode, a Φ20 mm upper electrode is lowered until it comes into contact with the dielectric layer, and is further pushed by 5 μm. Then, sweep is performed at an AC voltage of 0.1 Vpp with a frequency of 0.01 Hz to 1 MHz at room temperature, and the relative dielectric constant at a frequency of 1 kHz is calculated.

### Method of Producing Dielectric Layer

The dielectric layer can be synthesized by, for example, the following steps A (i) to A(iii):
Step A(i): preparing a first mixture in which a polyol is mixed with a curing catalyst;
Step A(ii): preparing a second mixture in which the first mixture is mixed with an ionic liquid and a cyclic multidentate ligand; and
Step A(iii): preparing a mixture for forming a dielectric layer containing the second mixture and a polyisocyanate, and then allowing the polyol (when the ionic liquid contains a reactive functional group that reacts with an isocyanate group, the ionic liquid), (when the cyclic multidentate ligand contains a reactive functional group that reacts with an isocyanate group, the cyclic multidentate ligand), and the polyisocyanate in the mixture for forming a dielectric layer to react with each other to form a dielectric layer.

One form of the above method of producing a dielectric layer will be described. The method of producing a dielectric layer is not limited to this form.

In step A(i), a curing catalyst is mixed with polyol to prepare a first mixture. As the mixing method for preparing the first mixture, a known method such as mechanical stirring may be optionally used.

In step A(ii), an ionic liquid and a cyclic multidentate ligand are mixed with the first mixture prepared in step A(i) to prepare a second mixture. The order of mixing the ionic liquid and the cyclic multidentate ligand with the first mixture is not particularly limited. The ionic liquid and the cyclic multidentate ligand may be mixed simultaneously with the first mixture, or a mixture of the ionic liquid and the cyclic multidentate ligand prepared in advance may be mixed with the first mixture.

Finally, in step A(iii), a mixture for forming a dielectric layer containing the second mixture prepared in step A(ii) and a polyisocyanate having at least two isocyanate groups is prepared. Then, the hydroxyl group of the polyol (when the ionic liquid contains a reactive functional group that reacts with an isocyanate group, the reactive functional group of the ionic liquid), (when the cyclic multidentate ligand contains a reactive functional group that reacts with an isocyanate group, the reactive functional group of the cyclic multidentate ligand), and the isocyanate group of the polyisocyanate in the mixture for forming a dielectric layer are allowed to react with each other. Thus, a network structure through a urethane bond is formed, thereby providing a dielectric layer according to the present disclosure.

The method of forming a dielectric layer is not particularly limited, and examples of the method include a die molding method, an extrusion molding method, an injection molding method, and a coating molding method. The die molding method is, for example, a method in which a mixture for forming a dielectric layer is injected from an inlet, then heated at a temperature at which the mixture for forming a dielectric layer is cured, and demolded.

### Urethane Elastomer Having Phase Separation Structure

The urethane elastomer may be a urethane elastomer having a phase separation structure. It is preferable that the urethane elastomer has a matrix and domains dispersed in the matrix, the matrix contains at least one selected from the group consisting of polycarbonate urethane and polyester urethane, and the domains have a structure represented by Formula (1).

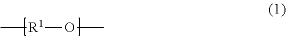

In Formula (1), R¹ represents a C3-C5 alkylene group.

In general, the polyether structure represented by Formula (1) has a weak intermolecular force between ether groups. Due to this, the hardness can be suppressed to an extremely low level, which is suitable for imparting flexibility to the urethane elastomer.

In addition to characteristics excellent in mechanical strength, wear resistance and dielectric breakdown resistance, the polycarbonate urethane and polyester urethane prepared by a reaction of polycarbonate polyol or polyester polyol with polyisocyanate are likely to exhibit high elasticity because of their strong intermolecular force between carbonate groups and between ester groups.

When the urethane elastomer is a polyol which has a matrix including at least one selected from the group consisting of polycarbonate urethane and polyester urethane, and in which domains dispersed in the matrix have the polyether structure represented by Formula (1), it is possible to achieve both excellent flexibility and excellent recoverability against deformation.

The urethane elastomer having a phase separation structure has a matrix-domain structure (phase separation structure), and thus each of the matrix and the domain has a different function. The matrix mainly plays a function of recoverability from deformation due to high elastic modulus, and the domain mainly plays a function of decreasing hardness.

Further, as will be described later, it is considered that in the urethane elastomer according to the present disclosure, the domain and the matrix are chemically bonded to each other through a urethane bond in a boundary portion between the domain and the matrix. Thus, it is considered that the recovery from deformation of the domain when the load applied to the urethane elastomer is removed progresses along with the recovery from deformation of the matrix. Consequently, it is considered that the urethane elastomer according to the present disclosure has extremely high recoverability from deformation. When such a urethane elastomer having a matrix-domain structure is adopted, the dielectric layer expresses softness and rapid recoverability from deformation.

Further, when a dielectric layer containing the urethane elastomer having a matrix-domain structure contains an ionic liquid, the dielectric layer exhibits a dielectric constant higher than that of a dielectric layer containing a urethane elastomer having no matrix-domain structure. That is, since the polyether structure of the domain traps and stabilizes the cation of the ionic liquid, the interaction between the ion pairs decreases. As a result, it is considered that the orientation polarization of the dipole increases as the average distance between the ion pairs increases.

The urethane elastomer can exhibit the above effect as long as it forms a matrix-domain structure, and part of the outer surface of the dielectric layer may be formed of the matrix. For example, the entire outer surface of the dielectric layer may be formed of the matrix.

In observation of the cross section of the dielectric layer with a scanning probe microscope, an area ratio of the area of the domain to the sum of the area of the matrix and the area of each of the domains [domain area/(matrix area+domain area)×100(%)] is preferably 8 to 55%, more preferably 10 to 50%, and even more preferably 20 to 40%.

As the polycarbonate urethane and the polyester urethane of the matrix in the urethane elastomer, those similar to the polycarbonate urethane and the polyester urethane described above may be used.

The number average molecular weight of the polycarbonate polyol and the polyester polyol as the raw materials is preferably 500 to 10000. More preferably, the number average molecular weight is 700 to 8000. When the number average molecular weight is at least 500, incompatibility with the domain is ensured and the phase separation between the matrix and the domain can be made clearer. Further, setting the number average molecular weight to not more than 10000 makes it possible to prevent an excessive increase in viscosity of the polycarbonate polyol and the polyester polyol.

The number average molecular weight of the polycarbonate polyol and the polyester polyol can be calculated in terms of standard polystyrene molecular weight or using a hydroxyl value (mgKOH/g) and a valence. The number average molecular weight in terms of polystyrene molecular weight can be measured using high performance liquid chromatography. For example, the measurement can be performed using two columns: Shodex GPCLF-804 (exclusion limit molecular weight: 2×10⁶, separation range: 3×10² to 2×10⁶) in series on a high-speed GPC device (trade name: HLC-8220GPC, manufactured by Tosoh Corporation).

When the hydroxyl value and the valence are used, the hydroxyl value and the valence can be calculated from the mathematical formula below. For example, the number average molecular weight of the polyol having 56.1 mgKOH/g and a valence of 2 may be calculated to be 2000.

Number average molecular weight=56.1×1000×valence/hydroxyl value

Next, the polyether structure represented by Formula (1) of the domains in the urethane elastomer will be described. In the structure represented by Formula (1) of the domains, R¹ represents a C3-C5 alkylene group. Preferably, R¹ represents a C3-C5 alkylene group having a branched structure.

The polyether structure in Formula (1) also has the effect of trapping and stabilizing the cation of the ionic liquid. Also, R¹ is a C3-C5 alkylene group, and thus the flexibility of the polymer chain is ensured. A case where R¹ is a C3-C5 alkylene group having a branched structure is more preferred from the viewpoint that the intermolecular force between ether groups can be further suppressed to be low, and low hardness can be realized.

Examples of R¹ include —(CH₂)ₘ-(m=3 to 5), —CH₂CH(CH₃)—, —CH₂C(CH₃)₂CH₂—, —CH₂CH(CH₃)CH₂—, and —(CH₂)₂CH(CH₃)CH₂—. In the urethane elastomer, R¹s may be identical or a combination of different R¹s.

The number average molecular weight (Mn) of the polyether structure represented by Formula (1) is preferably 1000 to 50000 as a repeating unit in the urethane elastomer, more preferably 1500 to 20000. When the number average molecular weight is at least 1000, the incompatibility with the polycarbonate polyol and the polyester polyol is ensured, and the phase separation between the matrix and domain of the resulting urethane elastomer is clarified, which is preferred. In addition, when the number average molecular weight is not more than 50000, domains are easily formed, and the form of phase separation is stabilized, which is preferred.

The number average molecular weight of the polyether structure can be calculated in a similar manner to the method for calculating the number average molecular weight of the polycarbonate polyol and the polyester polyol described above. Note that the chemical structures of the components included in the matrix and the domain can be analyzed using, for example, a spectrometer such as an AFM infrared spectrometer, a micro-infrared spectrometer, or a micro-Raman spectrometer, or a mass spectrometer.

Method of Producing Dielectric Layer in which Urethane Elastomer has Phase Separation Structure

The dielectric layer in which the urethane elastomer has a phase separation structure can be synthesized, for example, by the following steps B(i) to B(iv). The dielectric layer in which the urethane elastomer has a phase separation structure is preferably a dielectric layer manufactured by a method having the following steps B(i) to B(iv):
Step B(i): allowing a first urethane prepolymer having at least one (preferably at least two) isocyanate group(s) to react with a first polycarbonate polyol and/or a first polyester polyol having at least two hydroxyl groups to form a second urethane prepolymer having at least two hydroxyl groups;
Step B(ii): preparing a first dispersion in which droplets containing at least part of a second urethane prepolymer are dispersed in a second polycarbonate polyol and/or a second polyester polyol (which may be an excess unreacted product of the first polycarbonate polyol or the first polyester polyol).
Step B(iii): preparing a second dispersion in which an ionic liquid and a cyclic multidentate ligand is dispersed in the first dispersion; and
Step B(iv): preparing a mixture for forming a dielectric layer containing the second dispersion and a polyisocyanate having at least two isocyanate groups, and then allowing the second urethane prepolymer, the second polycarbonate polyol and/or the second polyester polyol (when the ionic liquid contains a reactive functional group that reacts with an isocyanate group, the reactive functional group of the ionic liquid), (when the cyclic multidentate ligand contains a reactive functional group that reacts with an isocyanate group, the cyclic multidentate ligand), and the polyisocyanate having at least two isocyanate groups in the mixture for forming a dielectric layer to react with one another to form a dielectric layer.

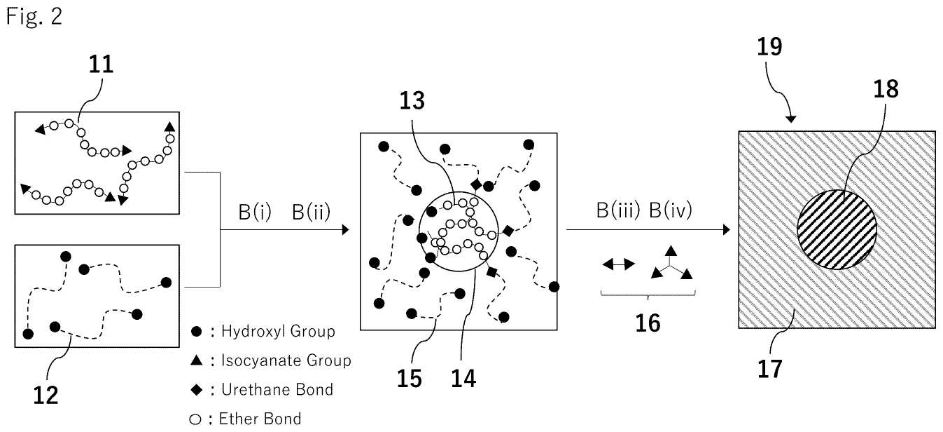

One form of the above method of producing a dielectric layer in which the urethane elastomer has a phase separation structure will be described with reference to FIG. 2. Note that the method of producing a dielectric layer in which the urethane elastomer has a phase separation structure is not limited to this form.

In step B(i), a first urethane prepolymer 11 having at least one (preferably at least two) isocyanate group(s) is mixed with a first polycarbonate polyol 12 and/or a first polyester polyol 12 having at least two hydroxyl groups. Next, the isocyanate group and the hydroxyl group in the resulting mixture are allowed to react with each other in the presence of a curing catalyst, and the isocyanate group and the hydroxyl group are connected to each other through a urethane bond to form a second urethane prepolymer 13 having at least two hydroxyl groups.

The first urethane prepolymer 11 is a polyether having at least one isocyanate group and having a structure represented by Formula (1). The first urethane prepolymer 11 can be prepared, for example, by steps as described below.

A polyether polyol having at least two hydroxyl groups and a structure represented by Formula (1) is allowed to react with a polyisocyanate having at least two isocyanate groups. Examples of the polyether polyol include: alkylene structure-containing polyether polyols, such as polypropylene glycol, polytetramethylene glycol, a copolymer of tetrahydrofuran and neopentyl glycol, and a copolymer of tetrahydrofuran and 3-methyltetrahydrofuran; and random or block copolymers of these polyalkylene glycols. These polyether polyols may be used singly, or in combination of two or more kinds thereof.

Among the polyether polyols, at least one selected from polypropylene glycol, polytetramethylene glycol, a copolymer of tetrahydrofuran and neopentyl glycol, and a copolymer of tetrahydrofuran and 3-methyltetrahydrofuran is preferably contained from the viewpoint that the mobility of ether groups is high, the cation stabilization effect is high, and hardness can be reduced. More preferably, at least polypropylene glycol is contained.

Examples of the polyisocyanate to be allowed to react with the polyether polyol include pentamethylene diisocyanate, hexamethylene diisocyanate, isophorone diisocyanate, 2,4-tolylene diisocyanate, 2,6-tolylene diisocyanate, xylylene diisocyanate, diphenylmethane diisocyanate, or a trimer compound (isocyanurate) or multimer compound of any of those polyisocyanates, an allophanate-type polyisocyanate, a biuret-type polyisocyanate, and a water dispersion-type polyisocyanate. These polyisocyanates may be used singly, or in combination of two or more kinds thereof.

Among the polyisocyanates exemplified above, a bifunctional isocyanate (diisocyanate) having two isocyanate groups is preferred because of high compatibility with the polyether polyol and ease of adjustment of physical properties such as viscosity. More preferably, among the polyisocyanates, at least one selected from hexamethylene diisocyanate, isophorone diisocyanate, 2,4-tolylene diisocyanate, 2,6-tolylene diisocyanate, xylylene diisocyanate, and diphenylmethane diisocyanate is contained. Xylylene diisocyanate is even more preferred.

In the step of allowing the polyether polyol having the structure represented by Formula (1) and the polyisocyanate to react with each other to form the first urethane prepolymer 11, an isocyanate index is preferably 0.05 to 8.0. More preferably, the isocyanate index is 0.1 to 5.0. When the isocyanate index falls within the above range, the amount of the component derived from the first urethane prepolymer, which remains without forming a network structure, is reduced, and the exudation of a liquid substance from the urethane elastomer can be suppressed.

The isocyanate index indicates a ratio ([NCO]/[OH]) of the number of moles of isocyanate groups in an isocyanate compound to the number of moles of hydroxy groups in a polyol compound.

As the urethanization catalyst of the first urethane prepolymer 11, the same catalyst as the curing catalyst of the urethane elastomer described above may be used.

In step B(ii), a dispersion in which a droplet 14 containing at least part of the second urethane prepolymer are dispersed in a second polycarbonate polyol 14 and/or a second polyester polyol 14. Here, the second urethane prepolymer can be mixed with the second polycarbonate polyol and/or the second polyester polyol newly added in this step.

The excess unreacted product of the first polycarbonate polyol and/or the first polyester polyol in step B(i) may also be used as the second polycarbonate polyol and/or the second polyester polyol.

The first urethane prepolymer 11 contained in the second urethane prepolymer 13 is incompatible with a second polycarbonate polyol 15 and/or a second polyester polyol 15, and thus the droplet 14 is formed.

Meanwhile, the first polycarbonate polyol and/or the first polyester polyol 12 included in the second urethane prepolymer 13 are compatible with the second polycarbonate polyol 15 and/or the second polyester polyol 15.

Thus, in the second polycarbonate polyol 15 and/or the second polyester polyol 15, the droplet 14 containing the first urethane prepolymer 11 forming part of the second urethane prepolymer 13 is uniformly and stably dispersed through the first polycarbonate polyol and/or the first polyester polyol 12. This results in a first dispersion in which the droplet 14 containing the first urethane prepolymer 11 is dispersed in the second polycarbonate polyol 15 and/or the second polyester polyol 15.

In step B(ii), the second polycarbonate polyol 15 and/or the second polyester polyol 15 that disperse the droplet 14 may be an unreacted product with the first urethane prepolymer of the first polycarbonate polyol and/or the first polyester polyol used in step B(i). That is, in the step B(i), the use of an excess amount of the first polycarbonate polyol and/or the first polyester polyol with respect to the first urethane prepolymer makes it possible to prepare a dispersion in which the second urethane prepolymer 13 is dispersed in the excess first polycarbonate polyol and/or first polyester polyol (i.e. the second polycarbonate polyol 15 and/or the second polyester polyol 15) as described in the step B(ii).

Even when the first polycarbonate polyol and/or the first polyester polyol are used in an excessive amount, a polycarbonate polyol and/or a polyester polyol (second polycarbonate polyol and/or second polyester polyol) as a dispersion medium of the second urethane prepolymer may also be additionally added. In this case, the polycarbonate polyol and/or polyester polyol to be added may have the same chemical composition as that of the first polycarbonate polyol and/or the first polyester polyol used in step B(i) or may be different therefrom.

Meanwhile, when the first polycarbonate polyol and/or the first polyester polyol are allowed to react with the first urethane prepolymer in equivalent amounts, the first polycarbonate polyol and/or the first polyester polyol is entirely consumed in step B(i), a new polycarbonate polyol and/or polyester polyol is used as the second polycarbonate polyol and/or the second polyester polyol to prepare a dispersion in step B (ii). Also in this case, the polycarbonate polyol and/or the polyester polyol used as the second polycarbonate polyol and/or the second polyester polyol have the same chemical composition as that of the first polycarbonate polyol and/or the first polyester polyol or may be different therefrom.

When the excess unreacted product of the first polycarbonate polyol and/or the first polyester polyol is used as the second polycarbonate polyol and/or the second polyester polyol, step B(i) may be performed simultaneously with step B(ii).

In step B(iii), an ionic liquid and a cyclic multidentate ligand are dispersed in the first dispersion prepared in step B(ii) to prepare a second dispersion. The order of mixing the ionic liquid and the cyclic multidentate ligand with the first mixture is not particularly limited. The ionic liquid and the cyclic multidentate ligand may be mixed simultaneously with the first mixture, or a mixture of the ionic liquid and the cyclic multidentate ligand prepared in advance may be allowed to mix with the first mixture.

Finally, in step B(iv), a mixture for forming a dielectric layer containing the second dispersion prepared in step B(iii) and a polyisocyanate having at least two isocyanate groups is prepared. Then, the terminal hydroxyl group of the second urethane prepolymer 13, the hydroxyl group of the second polycarbonate polyol 15 and/or the second polyester polyol 15 (when the ionic liquid contains a reactive functional group that reacts with an isocyanate group, the reactive functional group of the ionic liquid), (when the cyclic multidentate ligand contains a reactive functional group that reacts with an isocyanate group, the reactive functional group of the cyclic multidentate ligand), and the isocyanate group of a polyisocyanate 16 in the mixture for forming a dielectric layer are allowed to react with each other.

Thus, the mixture for forming a dielectric layer is cured to form a network structure through a urethane bond, thereby preparing a dielectric layer in which the urethane elastomer according to the present disclosure has a phase separation structure. The resulting dielectric layer has a matrix-domain structure in which the domains each including the polyether structure derived from the first urethane prepolymer are dispersed in the matrix including the first polycarbonate polyol and/or the first polyester polyol and the polycarbonate and/or the urethane elastomer including the polyester structure derived from the second polycarbonate polyol and/or the second polyester polyol.

In addition, the domain mainly includes a polyether structure, and the inside of the domain may be substantially free of a crosslinked structure. In other words, the domain may be present in the matrix in a substantially liquid state. With this configuration, in the dielectric layer according to the present disclosure, the domain can have a low elastic modulus.

Further, regarding the domain, a liquid portion is not simply confined in the matrix, but the domain and the matrix are chemically bonded to each other through a urethane bond in a boundary portion between the domain and the matrix. Thus, the recovery from deformation of the domain when the load applied to the dielectric layer is removed can be linked to the recovery from deformation of the matrix.

That is, the domain in a substantially liquid form is substantially free of a crosslinked structure therein. Thus, it is difficult for the domain, which is deformed by applying a load to the dielectric layer, to recover from deformation autonomously. However, in the dielectric layer according to the present disclosure, the domain is chemically bonded to the matrix in a boundary portion with the matrix (urethane bond), and hence the domain can also recover from deformation together with the deformation recovery of the matrix. As a result, stable deformation (deformation amount) and excellent recovery from the deformation are achieved even when the dielectric layer is repeatedly subjected to the application and removal of a load.

The ionic liquid and the cyclic multidentate ligand are preferably predominantly distributed in the matrix having a urethane bond as much as possible from the viewpoint of increasing the dielectric constant. Thus, it is preferable that the ionic liquid and the cyclic multidentate ligand are dispersed after step B(ii) as described above. In step B(ii), the interface between the matrix and the domain is firmly formed through a chemical bond (urethane bond). Accordingly, entry of the ionic liquid and the cyclic multidentate ligand into the domain is suppressed, thereby realizing a state in which the ionic liquid and the cyclic multidentate ligand are predominantly distributed in the matrix. Alternatively, in step B(ii), the second polycarbonate polyol and/or the second polyester polyol in which the ionic liquid and the cyclic multidentate ligand are dispersed in advance are used and step B(iii) is omitted, which enables the ionic liquid and the cyclic multidentate ligand to be sufficiently dispersed in the matrix.

Steps B(i) to B(iv) described above are steps of stably and uniformly dispersing a polyether polyol in a polycarbonate polyol and/or a polyester polyol when the compatibility between the polycarbonate polyol and/or the polyester polyol used as the matrix and the polyether polyol used as the domain is low. That is, the first urethane prepolymer is allowed to react with the first polycarbonate polyol and/or the first polyester polyol to form the second urethane prepolymer.

The step described above makes it possible to prepare a dispersion in which segments of the polyether structure derived from the first urethane prepolymer 11 are stably and uniformly dispersed in the second polycarbonate polyol and/or the second polyester polyol. As a result, it is easy to prepare a dielectric layer 19 in which domains 18 having high circularity, a small size on the order of micrometers and a relatively uniform size distribution are dispersed in a matrix 17.

As another method of mixing materials having low compatibility with each other, there is given, for example, a method involving mixing and dispersing the materials with a high shearing force. However, in this method, as a result of the application of a high shearing force to the polyether, the shape of each of the domains gets distorted to decrease circularity, and the sizes of the domains may also become ununiform. In addition, the dispersed state is also unstable, and the aggregation of the domains progresses in a relatively short period of time. In addition, the incompatibility between the polycarbonate polyol and/or the polyester polyol and the polyether polyol is not ensured, and the phase separation between the matrix and the domains of a urethane elastomer to be prepared is made unclear. Thus, unclear phase separation also affects mechanical characteristics, and it may be difficult to prepare a dielectric layer that is flexible and is excellent in deformation recoverability according to the present disclosure.

The ratio of the polyether polyol and the polycarbonate polyol and/or the polyester polyol to be used is not particularly limited and may be an amount that allows the droplets 14 to be dispersed in the second polycarbonate polyol and/or the second polyester polyol 15 to form clear domains. For example, the total of the polyether polyol: the polycarbonate polyol and the polyester polyol is preferably 15:85 to 50:50, more preferably 20:80 to 45:55 based on mass. The oxygen derived from the ether bond in the polyether polyol can also electrically interact with the cation of the ionic liquid with the lone electron pair to reduce the molecular mobility of the ionic liquid, and thus the relative dielectric constant increases as the ratio of the polyether polyol increases.

As the polyisocyanate 16 having at least two isocyanate groups to be used in step B(iv), the same polyisocyanate as exemplified above may be used as a raw material of the first urethane prepolymer. The polyisocyanates exemplified above may be used singly or in combination of two or more kinds thereof. Among the polyisocyanates exemplified above, the polyisocyanate used in step B(iv) preferably includes a polyisocyanate having at least three isocyanate groups, such as a trimer compound (isocyanurate) or a multimer compound of a polyisocyanate, an allophanate-type polyisocyanate, or a biuret-type polyisocyanate, from the viewpoint of increasing the elastic modulus of the matrix.

More preferably, at least one selected from the group consisting of a trimer compound of pentamethylene diisocyanate (isocyanurate), a trimer compound of hexamethylene diisocyanate (isocyanurate), and a multimer compound of diphenylmethane diisocyanate (polymeric MDI) may be used. One of these compounds may be used singly, or the catalysts may be mixed for use.

Among the above compounds, polymeric MDI is preferred. Here, the polymeric MDI is a mixture of monomeric MDI and a high molecular weight polyisocyanate, and is represented by the following Formula (A). n in Formula (A) is preferably from 0 to 4.

As the polymeric MDI, a commercially available product may be used, and examples of the product include Millionate MR series (manufactured by Tosoh Corporation) such as Millionate MR200 (trade name).

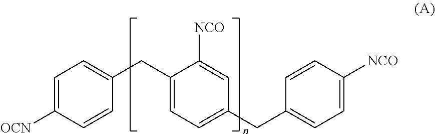

As the polyisocyanate 16 having at least two isocyanate groups, a polyisocyanate having at least three isocyanate groups, such as polymeric MDI, and a bifunctional isocyanate having two isocyanate groups are preferably used in combination. That is, the polyisocyanate preferably contains a bifunctional isocyanate and a polyisocyanate having at least three isocyanate groups. The crosslinking density can be controlled by the combination described above, and thus this is preferred from the viewpoint of achieving both low hardness and low compression set.

The amounts of the polyisocyanate having at least three isocyanate groups and the bifunctional isocyanate having two isocyanate groups are not particularly limited. The amount of difunctional isocyanate: polyisocyanate having at least 3 isocyanate groups when mixed with the dispersion in step B(iv) is preferably 3:1 to 1:10, more preferably 1:1 to 1:6. The amount of the polyisocyanate with respect to 100 parts by mass of the dispersion in the step B(iv) is also not particularly limited. For example, the amount is 1 to 12 parts by mass, and 3 to 10 parts by mass.

In the method of producing a dielectric layer in which the urethane elastomer has a phase separation structure, a chain extender (polyfunctional low molecular weight polyol) may be used, if necessary. As the chain extender, the same chain extender as described above may be used.

If necessary, additives such as a conductive agent, a pigment, a plasticizer, a waterproof agent, an antioxidant, an ultraviolet absorber, and a light stabilizer may be used in combination.

### Average Circularity of Domains

Further, when observation areas of 50 μm square were placed at three places in the cross section of the dielectric layer, and observed, the average circularity of the domains is preferably 0.60 to 1.00. Also, the average circularity of the domains is more preferably 0.80 to 1.00, even more preferably 0.90 to 1.00.

When the average circularity of the domains is within the above range, the domains are less likely to exhibit anisotropy in a direction in which the shape of the domains recovers when the domains recover from deformation. As a result, wrinkles, strain, and the like due to the anisotropy of the deformation recovery hardly occur after recovery from deformation, thereby achieving a dielectric layer in which the recovery from deformation is more isotropic.

The average circularity of the domains can be adjusted, for example, by a rate at which a material is injected into a mold. When the injection rate is reduced, the shearing force applied to the material is also reduced, and the material can be heated and cured while maintaining high circularity.

### Parameters Indicating Viscoelastic Term

Further, in the dielectric layer, the elastic modulus of the domains is preferably designed to be lower than that of the matrix. Specifically, a parameter indicating a viscoelastic term of each of the domains is defined as a parameter A, and a parameter indicating a viscoelastic term of the matrix is defined as a parameter B, the parameters A and B being measured in a viscoelastic image of a cross section in which the matrix and the domains are exposed with a scanning probe microscope. In this case, it is preferable that the parameters A and B satisfy A<B.

The relative difference in elastic modulus between the matrix and the domains in the dielectric layer may be measured by observing the thin dielectric layer with a scanning probe microscope (SPM/AFM). As the scanning probe microscope, “S-Image” (trade name) manufactured by Hitachi High-Tech Science Corporation may be used. In addition, examples of devices for thinning the dielectric layer include a sharp razor blade, a microtome, and a focused ion beam (FIB) method. Among the above devices, ultramicrotome capable of preparing ultra-thin sections can be used particularly suitably. A total of three sections are prepared, observation areas of 50 μm square are selected, and viscoelastic images are observed in a total of three observation regions.

The measurement mode of the viscoelastic image with the SPM is microviscoelastic dynamic force mode (referred to as “viscoelastic dynamic force mode (VE-DFM)”). In addition, a microcantilever for DFM made of silicon (“SI-DF3” (trade name), manufactured by Hitachi High-Tech Science Corporation, spring constant=1.9 N/m) is used as a cantilever. Furthermore, a scanning frequency is set to 0.5 Hz.

The microviscoelastic DFM (VE-DFM) is a mode in which a surface profile image is obtained while the distance between a probe and a measurement sample is controlled so that the vibration and amplitude of a cantilever become constant under a state in which the cantilever is resonated, and simultaneously, the distribution of viscoelasticity is measured. In the VE-DFM, the distribution of viscoelasticity is imaged from the deflection amplitude of the cantilever when the sample is slightly vibrated in the Z direction and a periodic force is applied. When the sample is hard, the amplitude of the cantilever becomes large as the deformation of the sample is small, whereas when the sample is soft, deformation vibration of the sample is induced, and the amplitude of the cantilever becomes small. The resulting amplitude is converted to mV as a displacement and is a parameter indicating the viscoelastic term. Therefore, the parameter A and the parameter B are indices indicating the relationship between the hardness of the domains and the hardness of the matrix present in one observation sample. In the VF-DFM, the magnitude of the amplitude of the cantilever is output as a voltage, the unit of the parameter A and the parameter B is mV. The larger the value, the higher the elasticity.

After the viscoelastic image had been acquired, parameters each indicating the viscoelastic term in each of the observation areas were determined at 10 points in each of the matrix and the domain, and the arithmetic mean values thereof were adopted as a parameter A indicating the viscoelastic term of the domain and a parameter B indicating the viscoelastic term of the matrix. The measurement procedure will be described later.

A ratio (A/B) of the parameter A (mV) to the parameter B (mV) is preferably not more than 0.65, more preferably not more than 0.60, more preferably not more than 0.50, even more preferably not more than 0.45, and particularly preferably not more than 0.40. The smaller the ratio A/B is, the larger the difference in viscoelasticity between the matrix and the domain is, and thus it is easy to achieve both hardness and recovery of deformation. The lower limit of the ratio A/B is not particularly limited, but is preferably as small as possible. Specifically, the lower limit is, for example, 0.10. A preferred range of the ratio A/B is, for example, from 0.10 to 0.65, from 0.10 to 0.60, from 0.10 to 0.50, particularly from 0.10 to 0.45, and further from 0.10 to 0.40.

The parameters A and B can be adjusted by, for example, the elastic moduli of the domain and the matrix. The elastic modulus of the matrix can be increased, for example, by increasing the crosslinking density of the matrix using a trimer compound or a multimer compound of a polyisocyanate as a raw material for forming the matrix. Regarding the elastic modulus of the domain, for example, an increase in the molecular weight of a polyether polyol as a raw material for forming the domain results in a decrease in the crosslinking density of the domain, and the elastic modulus decreases.

### Microrubber Hardness of Dielectric Layer

The microrubber hardness of the dielectric layer at a temperature of 23° C. is, for example, 15 to 60 degrees, preferably 20 to 50 degrees, more preferably 20 to 35 degrees. When the microrubber hardness is within the above range, the micro-rubber can be flexibly deformed against an external force such as compression or tension.

The microrubber hardness can be adjusted by the elastic modulus of the matrix, the proportion between the matrix and the domain, and the like. Specifically, for example, increasing the elastic modulus of the matrix and decreasing the proportion (volume) of the domain to the matrix act in a direction of increasing the microrubber hardness.

The microrubber hardness is measured on the surface of the dielectric layer at a temperature of 23° C. using a microrubber hardness meter (trade name: MD-1capa; manufactured by Kobunshi Keiki Co., Ltd., indenter: type A (cylindrical shape, diameter: 0.16 mm, height: 0.5 mm, outer diameter: 4 mm, inner diameter: 1.5 mm), measurement mode: peak hold mode).

Recoverability from Deformation

In an indentation test using a nanoindenter on the dielectric layer at a temperature of 23° C., when a Vickers indenter is brought into contact with an outer surface of the dielectric layer, the Vickers indenter is indented into an elastic layer at a loading speed of 10 mN/30 seconds, and is maintained at a load of 10 mN for 60 seconds, followed by unloading. It is preferable that the strain after 5 seconds of unloading is not more than 1.00 μm. The strain after 5 seconds of unloading is more preferably not more than 0.55 μm, more preferably not more than 0.50 μm, and even more preferably not more than 0.40 μm. Also, the lower limit of the strain after 5 seconds of unloading is not particularly limited. Ordinarily, the lower limit is at least 0.00 μm, and may be at least 0.05 μm, and may be at least 0.10 μm. Preferably, the lower limit is, for example, 0.00 to 1.00 μm, 0.00 to 0.55 μm, 0.00 to 0.50 μm, and 0.00 to 0.40 μm.

Strain after 5 seconds of unloading as measured under the above conditions is set to the above range, and thus, for example, when the dielectric layer is applied as a sensor, the speed when the compressed and deformed dielectric layer is unloaded and recovered from deformation is increased, and the responsiveness of the sensor is improved.

As described above, in the urethane elastomer, it is considered that the matrix and the domain are chemically bonded through a urethane bond in a boundary portion between the matrix and the domain. Thus, it is considered that the recovery from deformation of the domain when the load applied to the dielectric layer is removed is linked to the recovery from deformation of the matrix. As a result, the recoverability from deformation is extremely enhanced, and thus it is considered that strain after 5 seconds from the unloading can be set within the above range.

The strain after 5 seconds from the unloading can be adjusted, for example, by the elastic modulus of the matrix on the premise that the matrix and the domain are chemically bonded. Specifically, for example, as at least one of raw materials for the urethane elastomer, a trimer compound or a multimeric compound of a polyisocyanate is used to increase the crosslinking density of the matrix of the urethane elastomer, thereby increasing the elastic modulus of the matrix.

The value of strain after 5 seconds from unloading is a value obtained by an indentation test using a micro-hardness tester (nanoindenter). The measurement temperature is 23° C. In addition, as the indenter used for the measurement, a square pyramid type Vickers indenter having a facing angle of 136° is used. In the measurement method, the Vickers indenter is brought into contact with the outer surface of the dielectric layer, the Vickers indenter is indented at a loading speed of 10 mN/30 seconds and maintained at a load of 10 mN for 60 seconds. Then, the load is removed (unloading) at an unloading speed of 10 mN/l second, and the strain of the dielectric layer after 5 seconds from the unloading is measured.

### Transducer

At least one aspect of the present disclosure provides a transducer capable of converting from mechanical energy to electrical energy and/or from mechanical energy to electrical energy, the transducer including the above-described dielectric layer. Hence, the present disclosure includes, for example, a transducer capable of converting from mechanical energy to electrical energy, a transducer capable of converting from electrical energy to mechanical energy, and a transducer capable of mutually converting from electrical energy and mechanical energy.

The transducer includes at least two electrodes and the dielectric layer interposed between the electrodes. Power sources or wiring lines for applying a current to a control element may be connected to the electrodes. In addition, a laminated structure in which dielectric layers and electrodes are alternately laminated may be employed.

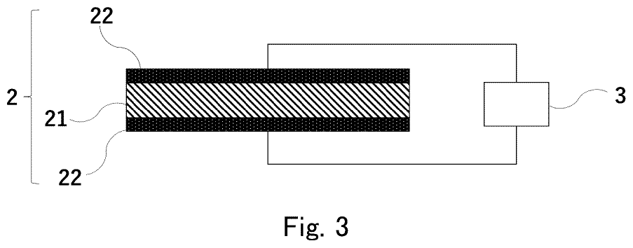

FIG. 3 shows an example of a transducer according to the present disclosure. A transducer 2 has a dielectric layer 21 according to the present disclosure and a pair of electrodes 22 holding the dielectric layer 21 therebetween. The use of the transducer is not particularly limited, but the transducer can be used as, for example, a sensor, an actuator, or a power generating element.

When the transducer is used as a sensor, a deformation amount can be acquired by measuring a change in capacitance due to compression or contraction of the transducer 2 by an electric circuit device 3. When the transducer is used as an actuator, a driving force can be induced in the dielectric layer 21 by applying a difference in potential between the pair of electrodes 22 by the electric circuit device 3. When the transducer is used as a power generating element, electrical energy associated with deformation of the transducer can be produced, for example, by a known method described in Sustainability 2021, 13(17), 9881.

The thickness of the dielectric layer 21 may be appropriately determined depending on the intended use of the dielectric layer 21. For example, when the dielectric layer 21 is used as a sensor, it is preferable that the thickness is thin from the viewpoint of high capacitance, high resolution, and the like. Since the dielectric layer according to the present disclosure has a high relative dielectric constant, high capacitance and high resolution can be maintained. Thus, the thickness of the dielectric layer is preferably from 100 μm to 3 mm. Further, when the dielectric layer 21 is used as an actuator, it is also preferable that the thickness is thin from the viewpoint of size reduction, low voltage drive, and a larger displacement. In view of dielectric breakdown resistance, the thickness of the dielectric layer is preferably from 1 μm to 1000 μm.

The material of the electrode may be any ordinary conductive material, and examples of the material include: conductive carbon powders such as carbon black, carbon nanotubes, graphite, and graphene; metal powders such as silver, gold, copper, nickel, rhodium, palladium, chromium, titanium, platinum, iron, and alloys thereof, metal colloids such as colloidal silver; charge transfer complexes such as tetrathiafulvalene-tetracyanoquinodimethane; and conductive polymers such as polypyrrole and polythiophene. A material having elasticity that follows the expansion and contraction of the dielectric layer to be used is preferred. Such an electrode material is, for example, a composite material including the above-described conductive material and binder. Examples of the composite material include a composite material in which a conductive material filler is dispersed in an acryl-based, silicone-based, urethane-based or styrene-based elastomer material, silicone grease, or the like, and a composite material in which an organic solvent, a resin, a crosslinking agent, or the like is appropriately contained in an aqueous dispersion of poly(3,4-ethylenedioxythiophene)/poly(4-styrenesulfonic acid) (PEDOT/PSS).

A method of producing the transducer according to the present disclosure is not particularly limited, and examples of the method include a method of spraying an electrode material on the dielectric layer according to the present disclosure, a method of bonding the electrode material and the dielectric layer each other, a method of impregnating the dielectric layer with the electrode material, and a method of applying or printing the electrode material on the dielectric layer.

The use of the dielectric layer of the present disclosure having both high dielectric properties and flexibility as the dielectric layer of the transducer makes it possible to provide a sensor excellent in high capacitance, high resolution, and miniaturization in sensor applications. In addition, in actuator applications, it is possible to realize an actuator excellent in terms of increase in deformation amount, increase in output, high efficiency, drive stabilization, low voltage drive, and the like. Similarly, in a case where the transducer is used as a power generating element, it is possible to provide an element excellent in terms of high efficiency, high output, decrease in size, increase in power generation amount, and the like.

### EXAMPLES

The following examples will be used to explain the present disclosure, but the present disclosure is not limited to these.

### Example 1

### Preparation of Mixture for Forming Dielectric Layer

500 ppm of 1,4-diazabicyclo[2.2.2]octane-2-methanol (trade name: RZETA, manufactured by Tosoh Corporation) as a curing catalyst were added to 86.8 parts by mass of polycarbonate diol (trade name: KURARAY POLYOL C-2090, manufactured by Kuraray Co., Ltd.). The mixture was preheated to a temperature of 100° C., and then stirred for 2 minutes under the conditions of a speed of 800 rpm and a revolution speed of 1600 rpm using a rotation-revolution type vacuum defoaming mixer (step A(i)).

The amount of the curing catalyst is ppm by mass based on the mass of the mixture for forming a dielectric layer other than the curing catalyst, and the same applies to the following Examples and Comparative Examples.

2.0 parts by mass of 1-ethyl-3-methylimidazolium bis(trifluoromethanesulfonyl)imide (trade name: CIL-612, manufactured by Japan Carlit Co., Ltd.) and 1.3 parts by mass of 18 crown 6-ether (manufactured by Tokyo Chemical Industry Co., Ltd.) were added to the resulting mixture, and the mixture was preheated to a temperature of 100° C., and then stirred for 2 minutes under the conditions of a speed of 800 rpm and a revolution speed of 1600 rpm using the rotation-revolution type vacuum defoaming mixer (step A(ii)).

To this mixture, 4.3 parts by mass of xylylene diisocyanate (manufactured by Tokyo Chemical Industry Co., Ltd., hereinafter sometimes referred to as “XDI”) and 6.9 parts by mass of polyisocyanate (trade name: Millionate MR-200, manufactured by Tosoh Corporation, hereinafter sometimes referred to as “MR-200”) were added, and the mixture was stirred under the conditions of a rotation speed of 800 rpm and a revolution speed of 1600 rpm for 2 minutes using the rotation-revolution type vacuum defoaming mixer, and a mixture for forming a dielectric layer was prepared (step A(iii)).

### Formation of Dielectric Layer

The mixture for forming a dielectric layer was injected into a mold spaced at an interval of 1 mm over 10 seconds and then heated at a temperature of 130° C. for 2 hours, and the mixture was cured. Then, the cured product was demolded from the mold, and further aged at a temperature of 80° C. for 3 days to form a sheet-shaped dielectric layer having a size of 5 cm square and a thickness of 1 mm (step A(iii)). The resulting dielectric layer was evaluated as described below.

### Evaluation

### Evaluation 1: Confirmation and Analysis of Matrix and Domains

Ultra-thin sections (500 μm×500 μm×5 μm) were produced from the dielectric layer using a freeze-fracture system (trade name: EM FC6, manufactured by Leica Microsystems) and an ultramicrotome (trade name: EM UC6, manufactured by Leica Microsystems). The sections were produced at a total of three locations: the center of the dielectric layer and two locations sufficiently away from the center.

Mapping measurement was performed on the produced sections using infrared microscopy and imaging systems (trade names: Spectrum 400 (analyzer) and Spotlight 400 (scanning device), manufactured by PerkinElmer) to create mapping images. The mapping measurement was performed using ATR IMAGING ACCESSORY under the following conditions: Pixel size: 1.56 μm; Resolution: 16 cm¹; Field of view: 300 μm×300 μm; and Scan speed: 1.0 cm/s. The mapping image is created by imaging the magnitude of the integration value/integrated value of the infrared absorption spectrum for each pixel.

The presence of a matrix mapped as a continuous phase and a domain mapped as a discontinuous phase is confirmed from the resulting mapping image. Further, the structure included in the matrix is confirmed from the infrared absorption spectrum of the matrix of the mapping image. In Example 1, it was confirmed that the matrix included a structure corresponding to polycarbonate urethane.

### Evaluation 2: Evaluation of Relative Dielectric Constant

A sample of the dielectric layer is cut into a size of 1.5 cm×1.5 cm, and sandwiched between a 4-terminal sample holder (SH2-Z type, manufactured by TOYO Corporation) of a Φ10 mm lower electrode and a Φ20 mm upper electrode with a guard electrode. The upper electrode is lowered until it comes into contact with the dielectric layer, and further pushed by 5 μm from the contact point. An impedance analyzer (1260 A, manufactured by Solartron) and a dielectric interface (1296 A, manufactured by Solartron) were used to perform sweep with a frequency of 0.01 Hz to 1 MHz at an AC voltage of 0.1 Vpp at room temperature, and a relative dielectric constant ε′ at a frequency of 1 kHz was measured. The arithmetic mean value of three samples is adopted.

### Evaluation 3: Measurement of Microrubber Hardness of Dielectric Layer

The microrubber hardness of the dielectric layer was measured using a microrubber hardness meter (trade name: MD-1capa, manufactured by Kobunshi Keiki Co., Ltd.). In the measurement, the dielectric layer was left to stand in an environment at a temperature of 23° C. for 24 hours or longer, and the measurement was performed using a measuring device placed in the same environment. In addition, the used indenter was type A (indenter shape: height: 0.50 mm, diameter: 0.16 mm, cylindrical shape, pressing leg dimensions: outer diameter: 4 mm, inner diameter: 1.5 mm), and the measurement mode was a peak hold mode. The microrubber hardness was measured at a total of three locations: the center of the dielectric layer and two locations sufficiently away from the center. The microrubber hardness is measured once at each measurement site at a temperature of 23° C., and an arithmetic mean value at 3 measurement sites is adopted.

### Evaluation 4 Measurement of Deformation Recoverability

The deformation recoverability of the dielectric layer was evaluated in an indentation test with a nanoindenter (trade name: HM2000, manufactured by Fischer Instruments K.K.) at a temperature of 23° C. In the measurement, the dielectric layer was left to stand in an environment at a temperature of 23° C. for 24 hours or longer, and the measurement was performed with a measuring device placed under the same environment.

The measurement was performed at a total of three points including the center of the dielectric layer and two points sufficiently away from the center. In the indentation test, the Vickers indenter was brought into contact with the outer surface of the dielectric layer, and the Vickers indenter (square pyramid type, facing angle: 136°) was indented at a loading speed of 10 mN/30 seconds and maintained at a load of 10 mN for 60 seconds. Thereafter, unloading is performed at an unloading speed of 10 mN/see, strain after 5 seconds from completion of unloading is measured once at each of the measurement sites, and an arithmetic mean value at three measurement sites is adopted.

### Examples 2 to 14

Dielectric layers were formed in the same manner as in Example 1, except that a mixture for forming a dielectric layer was prepared using materials shown in Table 5 in compounding amounts shown in Table 5. The resulting dielectric layers were evaluated in the same manner as in Example 1.

Note that the details of the materials in Table 5 are shown in Tables 1 to 4. The same applies to the following examples.

### Example 15

### Preparation of Mixture for Forming Dielectric Layer

500 ppm of 1,4-diazabicyclo[2.2.2]octane-2-methanol (trade name: RZETA, manufactured by Tosoh Corporation) as a curing catalyst was added to 26.1 parts by mass of polypropylene glycol (trade name: UNIOL D-4000, manufactured by NOF Corporation) and 2.4 parts by mass of xylylene diisocyanate (manufactured by Tokyo Chemical Industry Co., Ltd.). The mixture was stirred for 4 hours with a closed mixer adjusted to 100° C. to synthesize a first urethane prepolymer (step B(i)).

61.0 parts by mass of polycarbonate diol (trade name: Kuraray Polyol C-2090, manufactured by Kuraray Co., Ltd.) was mixed with the resultant. Thereafter, the mixture was further stirred for 2 hours with the closed mixer adjusted to 100° C. to synthesize a second urethane prepolymer (step B(i)) and prepare a dispersion in which droplets containing at least part of the second urethane prepolymer were dispersed in the polycarbonate diol (step B(ii)).

2.0 parts by mass of 1-ethyl-3-methylimidazolium bis(trifluoromethanesulfonyl)imide (trade name: CIL-612, manufactured by Japan Carlit Co., Ltd.) and 1.4 parts by mass of 18 crown 6-ether (manufactured by Tokyo Chemical Industry Co., Ltd.) were added to the dispersion, and the mixture was preheated to a temperature of 100° C., and then stirred for 2 minutes under the conditions of a speed of 800 rpm and a revolution speed of 1600 rpm using the rotation-revolution type vacuum defoaming mixer to prepare a second dispersion was prepared (step B(iii)).

Further, 1.2 parts by mass of xylylene diisocyanate (manufactured by Tokyo Chemical Industry Co., Ltd.) and 5.8 parts by mass of polyisocyanate (trade name: Millionate MR-200, manufactured by Tosoh Corporation) were added to the second dispersion, and the mixture was stirred under the conditions of a rotation speed of 800 rpm and a revolution speed of 1600 rpm for 2 minutes using the rotation-revolution type vacuum defoaming mixer to prepare a mixture for forming a dielectric layer (step B(iv)).

### Formation of Dielectric Layer

The mixture for forming a dielectric layer was injected into a mold spaced at an interval of 1 mm over 10 seconds and then heated at a temperature of 130° C. for 2 hours, and the mixture was cured. Then, the cured product was demolded from the mold, and further aged at a temperature of 80° C. for 3 days to form a sheet-shaped dielectric layer having a size of 5 cm square and a thickness of 1 mm (step B(iv)). The resulting dielectric layer was subjected to Evaluations 1 to 4 described above and evaluated as described below.

### Evaluation 5 Evaluation of Parameters Indicating Viscoelastic Term

An ultra-thin section was produced in the same manner as in Evaluation 1.

A total of three sections were produced, an observation area of 50 μm square was placed at the center of the section, and viscoelastic images in a total of three observation areas were observed. The viscoelastic images were measured at a total of three observation areas with a scanning probe microscope (trade name: S-Image, manufactured by Hitachi High-Tech Science America, Inc.).

The measurement mode of the viscoelastic image was VE-DFM. In addition, “SI-DF3” (trade name, manufactured by Hitachi High-Tech Science Corporation, spring constant=1.9 N/m) was used as a cantilever. Furthermore, a scanning frequency was set to 0.5 Hz.

From the resulting viscoelastic images, parameters each indicating the viscoelastic term in each of the observation areas were calculated at 10 points in each of the matrix and the domains, and from the arithmetic mean values thereof, the parameter A (mV) indicating the viscoelastic term of each of the domains and the parameter B (mV) indicating the viscoelastic term of the matrix were determined.

The viscoelastic image with the SPM was used to confirm the fact that the domains were exposed in the cross section and the matrix was exposed.

### Evaluation 6: Evaluation of Area Ratio of Domains

Each of the three viscoelastic images obtained in Evaluation 5 was converted into a 256-gradation grayscale image using image processing software (trade name: ImageProPlus, manufactured by Media Cybernetics Inc.), and then binarized to obtain a binarized image for analysis. A threshold for binarization from a brightness distribution of the monochromatic image was determined on the basis of the algorithm of Otsu described in IEEE Transactions on SYSTEMS, MAN, AND CYBERNETICS, Vol. SMC-9, No. 1, January 1979, pp. 62-66.

The count function of the image processing software was used in the binarized image to calculate the area of each of the domains. Of those determined to be domains with the count function, domains each having a sectional area of less than 0.05% with respect to the 50 μm square observation area be regarded as domains derived from noise and deleted from the data. The area corresponding to the matrix was calculated by subtracting the resultant area from the total area of the observation area. From these areas, an area ratio [domain area/(matrix area+domain area)×100(%)] was calculated.

### Evaluation 7: Average Circularity of Domains

From the binarized image without noise obtained in Evaluation 6, the average circularity of the domains was calculated using the count function of the image processing software.

### Examples 16 to 31

Dielectric layers were formed in the same manner as in Example 15, except that a mixture for forming a dielectric layer was prepared using materials shown in Table 5 in compounding amounts shown in Table 5. The resulting dielectric layers were evaluated in the same manner as in Example 1.

Note that the details of the materials in Table 5 are shown in Tables 1 to 4. The same applies to the following examples.

### Example 32

Dielectric layers were formed in the same manner as in Example 15, except that a mixture for forming a dielectric layer was prepared using materials shown in Table 5 in compounding amounts shown in Table 5, and the dielectric layer forming-mixture was injected into a mold in 5 seconds. The resulting dielectric layers were evaluated in the same manner as in Example 1.

TABLE 1

| No. | Material A | Mn |
|---|---|---|
| A1 | Polycarbonate polyol | 2,000 |
| | “KURARAY POLYOL C-2090” | |
| | (Trade name: manufactured by | |
| | KURARAY CO., LTD.) | |
| A2 | Polycarbonate diol | 2,000 |
| | “DURANOL T-6002” | |
| | (Trade name: manufactured by | |
| | ASAHI KASEI CORPORATION) | |
| A3 | Polyester polyol | 1,000 |
| | “NIPPOLAN 4009” | |
| | (Trade name: manufactured by | |
| | TOSOH CORPORATION) | |
| A4 | Polyester polyol | 2,000 |
| | “KURARAY POLYOL P-2050” | |
| | (Trade name: manufactured by | |
| | KURARAY CO., LTD.) | |

Mn represents a number average molecular weight.

TABLE 2

| | | Number of carbons of | |
|---|---|---|---|
| No. | Material B | R¹ in Formula (1) | Mn |
| B1 | Polypropylene glycol | 3 (branched) | 12,000 |
| | “PREMINOL S4013F” | | |
| | (Trade name: manufactured | | |
| | by AGC INC.) | | |
| B2 | Polypropylene glycol | 3 (branched) | 4,000 |
| | “UNIOL D-4000” | | |
| | (Trade name: manufactured | | |
| | by NOF CORPORATION) | | |
| B3 | Polypropylene glycol | 3 (branched) | 2,000 |
| | “UNIOL D-2000” | | |
| | (Trade name: manufactured | | |
| | by NOF CORPORATION) | | |
| B4 | Polytetramethylene glycol | 4 (linear) | 2,000 |
| | “PTMG2000” | | |
| | (Trade name: manufactured | | |
| | by MITSUBISHI CHEMICAL | | |
| | GROUP CORPORATION) | | |
| B5 | Copolymer of tetrahydrofuran | 4 (linear) | 1,800 |
| | and neopentyl glycol | +5 (branched) | |
| | “PTXG-1800” | | |
| | (Trade name: manufactured | | |
| | by ASAHI KASEI | | |
| | CORPORATION) | | |

TABLE 3

| No. | Material C | Hydroxyl group |
|---|---|---|
| C1 | 1-Ethyl-3-methylimidazolium | Absent |
| | bis(trifluoromethanesulfonyl)imide | |
| | “CIL-612” | |
| | (Trade name: manufactured by | |
| | Japan Carlit Co., Ltd.) | |
| C2 | 1,3-Bis(2-hydroxyethyl)imidazolium | Present in cation |
| | bis(trifluoromethanesulfonyl)imide | |
| | (Synthesized by the method disclosed | |
| | in Japanese patent application | |
| | publication No. 2021-113853) | |
| C3 | Methyl tri-N-octylammonium | Absent |
| | bis(trifluoromethanesulfonyl)imide | |
| | “CIL-552” | |
| | (Trade name: manufactured by | |
| | Japan Carlit Co., Ltd.) | |
| C4 | N,N-(2-hydroxyethyl)-N-(9- | Present in cation |
| | octadecene)-N-methylammonium | |
| | bis(trifluoromethanesulfonyl)imide | |
| | “CIL-542” | |
| | (Trade name: manufactured by | |
| | Japan Carlit Co., Ltd.) | |
| C5 | 1-butyl-3-methylimidazolium | Present in anion |
| | hydrogen sulfate | |
| | (manufactured by TOKYO | |
| | CHEMICAL INDUSTRY CO., LTD.) | |

TABLE 4

| | | | Number of | Number of | Number of |
|---|---|---|---|---|---|
| | | Hydroxyl | R²/n | R³/n | R⁴/R⁵ |
| No. | Material D | group | in Formula (2) | in Formula (3) | in Formula (4) |
| D1 | 12-Crown 4-ether | Absent | Ethylene/4 | — | — |
| | (manufactured by | | | | |
| | TOKYO CHEMICAL | | | | |
| | INDUSTRY CO., LTD.) | | | | |
| D2 | 18-Crown 6-ether | Absent | Ethylene/6 | — | — |
| | (manufactured by | | | | |
| | TOKYO CHEMICAL | | | | |
| | INDUSTRY CO., LTD.) | | | | |
| D3 | 24-Crown 8-ether | Absent | Ethylene/8 | — | — |
| | (manufactured by | | | | |
| | TOKYO CHEMICAL | | | | |
| | INDUSTRY CO., LTD.) | | | | |
| D4 | 2-(Hydroxy)-18-crown | Present | Ethylene/6 | — | — |
| | 6-ether | | | | |
| | (manufactured by | | | | |
| | TOKYO CHEMICAL | | | | |
| | INDUSTRY CO., LTD.) | | | | |
| D5 | 4-Tert- | Present | — | Tert-butyl/4 | — |
| | butylcalix[4]arene | | | | |
| | (manufactured by | | | | |
| | TOKYO CHEMICAL | | | | |
| | INDUSTRY CO., LTD.) | | | | |
| D6 | 4-Tert- | Present | — | Tert-butyl/6 | — |
| | butylcalix[6]arene | | | | |
| | (manufactured by | | | | |
| | TOKYO CHEMICAL | | | | |
| | INDUSTRY CO., LTD.) | | | | |
| D7 | Tetraphenylporphyrin | Absent | — | — | Phenyl/hydrogen |
| | (manufactured by | | | | |
| | TOKYO CHEMICAL | | | | |
| | INDUSTRY CO., LTD.) | | | | |

TABLE 5

| | | | | | | | | | | | | Parts by |
|---|---|---|---|---|---|---|---|---|---|---|---|---|
| | | | | | | | | | | | | mass of |
| | | | | | | | | | Parts by | | Parts by | MR-200 in |
| | Material A | | Material B | | Material C | | Material D | | mass of | | mass of | Step A(iii) |
| | | Parts | | Parts | | Parts | | Parts | XDI in | | XDI in | or |
| Examples | Type | by mass | Type | by mass | Type | by mass | Type | by mass | Step A(iii) | X | Step B(iv) | Step B(iv) |
| 1 | A1 | 86.8 | — | — | C1 | 2.0 | D2 | 1.3 | 4.3 | — | — | 6.9 |
| 2 | A3 | 78.3 | — | — | C1 | 2.0 | D2 | 1.3 | 7.6 | — | — | 12.2 |
| 3 | A1 | 85.0 | — | — | C1 | 4.0 | D2 | 2.7 | 4.2 | — | — | 6.8 |
| 4 | A3 | 76.6 | — | — | C1 | 4.0 | D2 | 2.7 | 7.5 | — | — | 11.9 |
| 5 | A1 | 77.3 | — | — | C2 | 2.0 | D2 | 1.2 | 8.0 | — | — | 12.7 |
| 6 | A1 | 78.3 | — | — | C3 | 2.0 | D2 | 0.8 | 7.6 | — | — | 12.2 |
| 7 | A1 | 86.0 | — | — | C4 | 2.0 | D2 | 0.8 | 4.6 | — | — | 7.4 |
| 8 | A1 | 85.8 | — | — | C5 | 2.0 | D2 | 2.3 | 4.7 | — | — | 7.5 |
| 9 | A1 | 85.9 | — | — | C1 | 2.0 | D1 | 0.9 | 4.3 | — | — | 6.8 |
| 10 | A1 | 85.1 | — | — | C1 | 2.0 | D3 | 1.8 | 4.2 | — | — | 6.8 |
| 11 | A1 | 85.4 | — | — | C1 | 2.0 | D4 | 1.5 | 4.3 | — | — | 6.8 |
| 12 | A1 | 83.8 | — | — | C1 | 2.0 | D5 | 3.3 | 4.2 | — | — | 6.7 |
| 13 | A1 | 82.5 | — | — | C1 | 2.0 | D6 | 4.9 | 4.1 | — | — | 6.6 |
| 14 | A1 | 84.0 | — | — | C1 | 2.0 | D7 | 3.1 | 4.2 | — | — | 6.7 |
| 15 | A1 | 61.0 | B2 | 26.1 | C1 | 2.0 | D2 | 1.4 | — | 2.4 | 1.2 | 5.8 |
| 16 | A1 | 60.2 | B2 | 25.8 | C1 | 2.0 | D2 | 2.7 | — | 2.4 | 1.2 | 5.7 |
| 17 | A1 | 57.2 | B2 | 24.5 | C1 | 4.0 | D2 | 5.4 | — | 2.3 | 1.2 | 5.4 |
| 18 | A1 | 62.7 | B2 | 24.9 | C2 | 2.0 | D2 | 1.6 | — | 2.3 | 1.7 | 6.4 |
| 19 | A1 | 60.8 | B2 | 26.1 | C3 | 2.0 | D2 | 1.7 | — | 2.4 | 1.2 | 5.8 |
| 20 | A1 | 62.5 | B2 | 24.8 | C4 | 2.0 | D2 | 2.4 | — | 2.3 | 1.8 | 6.6 |
| 21 | A1 | 62.5 | B2 | 24.8 | C5 | 2.0 | D2 | 4.4 | — | 2.4 | 1.8 | 6.5 |
| 22 | A1 | 60.7 | B2 | 26.0 | C1 | 2.0 | D1 | 1.8 | — | 2.4 | 1.2 | 5.8 |
| 23 | A1 | 59.6 | B2 | 25.5 | C1 | 2.0 | D3 | 3.6 | — | 2.4 | 1.2 | 5.7 |
| 24 | A1 | 60.0 | B2 | 25.7 | C1 | 2.0 | D4 | 3.0 | — | 2.4 | 1.2 | 5.7 |
| 25 | A1 | 57.6 | B2 | 24.7 | C1 | 2.0 | D5 | 6.7 | — | 2.3 | 1.2 | 5.5 |
| 26 | A1 | 55.5 | B2 | 23.8 | C1 | 2.0 | D6 | 10.1 | — | 2.2 | 1.1 | 5.3 |
| 27 | A1 | 57.9 | B2 | 24.8 | C1 | 2.0 | D7 | 6.3 | — | 2.3 | 1.2 | 5.5 |
| 28 | A1 | 58.9 | B5 | 25.3 | C1 | 2.0 | D2 | 2.7 | — | 2.8 | 1.5 | 6.8 |
| 29 | A1 | 59.0 | B4 | 25.3 | C1 | 2.0 | D2 | 2.7 | — | 2.7 | 1.6 | 6.7 |
| 30 | A4 | 44.2 | B1 | 44.2 | C1 | 2.0 | D2 | 2.7 | — | 1.5 | 1.2 | 4.2 |
| 31 | A2 | 75.8 | B2 | 8.4 | C1 | 2.0 | D2 | 2.7 | — | 1.6 | 2.7 | 6.8 |
| 32 | A1 | 60.2 | B2 | 25.8 | C1 | 2.0 | D2 | 2.7 | — | 2.4 | 1.2 | 5.7 |

X: Parts by mass of XDI when producing first urethane prepolymer in Step B(i)

### Comparative Example 1

500 ppm of 1,4-diazabicyclo[2.2.2]octane-2-methanol (trade name: RZETA, manufactured by Tosoh Corporation) as a curing catalyst was added to 86.8 parts by mass of polycarbonate diol (trade name: KURARAY POLYOL C-2090, manufactured by Kuraray Co., Ltd.). The mixture was preheated to a temperature of 100° C., and then stirred for 2 minutes under the conditions of a speed of 800 rpm and a revolution speed of 1600 rpm using a rotation-revolution type vacuum defoaming mixer.

2.0 parts by mass of 1-ethyl-3-methylimidazolium bis(trifluoromethanesulfonyl)imide (trade name: CIL-612, manufactured by Japan Carlit Co., Ltd.) was added to the resulting mixture, and the mixture was preheated to a temperature of 100° C., and then stirred for 2 minutes under the conditions of a speed of 800 rpm and a revolution speed of 1600 rpm using the rotation-revolution type vacuum defoaming mixer.

To this mixture, 4.3 parts by mass of xylylene diisocyanate (manufactured by Tokyo Chemical Industry Co., Ltd.) and 6.9 parts by mass of polyisocyanate (trade name: Millionate MR-200, manufactured by Tosoh Corporation) were added, and the mixture was stirred under the conditions of a rotation speed of 800 rpm and a revolution speed of 1600 rpm for 2 minutes using the rotation-revolution type vacuum defoaming mixer.

The resulting mixture was injected into a mold spaced at an interval of 1 mm over 10 seconds and then heated at a temperature of 130° C. for 2 hours, and the mixture was cured. Subsequently, the cured product was demolded from the mold, and further aged at a temperature of 80° C. for 3 days to form a sheet-shaped dielectric layer having a size of 5 cm square and a thickness of 1 mm. The resulting dielectric layers were evaluated in the same manner as in Example 1.

### Comparative Example 2

500 ppm of 1,4-diazabicyclo[2.2.2]octane-2-methanol (trade name: RZETA, manufactured by Tosoh Corporation) as a curing catalyst were added to 86.8 parts by mass of polycarbonate diol (trade name: KURARAY POLYOL C-2090, manufactured by Kuraray Co., Ltd.). The mixture was preheated to a temperature of 100° C., and then stirred for 2 minutes under the conditions of a speed of 800 rpm and a revolution speed of 1600 rpm using a rotation-revolution type vacuum defoaming mixer. 1.3 parts by mass of 18-crown 6-ether (manufactured by Tokyo Chemical Industry Co., Ltd.) was added to the resulting mixture, the mixture was preheated to a temperature of 100° C., and then stirred under the conditions of a speed of 800 rpm and a revolution speed of 1600 rpm for 2 minutes using the rotation-revolution type vacuum defoaming mixer.

To this mixture, 4.3 parts by mass of xylylene diisocyanate (manufactured by Tokyo Chemical Industry Co., Ltd.) and 6.9 parts by mass of polyisocyanate (trade name: Millionate MR-200, manufactured by Tosoh Corporation) were added, and the mixture was stirred under the conditions of a rotation speed of 800 rpm and a revolution speed of 1600 rpm for 2 minutes using the rotation-revolution type vacuum defoaming mixer.

The resulting mixture was injected into a mold spaced at an interval of 1 mm over 10 seconds and then heated at a temperature of 130° C. for 2 hours, and the mixture was cured. Subsequently, the cured product was demolded from the mold, and further aged at a temperature of 80° C. for 3 days to form a sheet-shaped dielectric layer having a size of 5 cm square and a thickness of 1 mm. The resulting dielectric layers were evaluated in the same manner as in Example 1.

### Comparative Example 3

0.50 parts by mass of a 2-propanol solution of 1 (mmol/L) chloroplatinic acid (manufactured by FUJIFILM Wako Pure Chemical Corporation) as a curing catalyst was added to 89.2 parts by mass of vinyl terminated polydimethylsiloxane (trade name: DMS-V31, manufactured by ASMAX Corporation). The mixture was stirred under the conditions of a speed of 800 rpm and a revolution speed of 1600 rpm for 2 minutes using the rotation-revolution type vacuum defoaming mixer.

2.0 parts by mass of 1-ethyl-3-methylimidazolium bis(trifluoromethanesulfonyl)imide (trade name: CIL-612, manufactured by Japan Carlit Co., Ltd.) and 1.3 parts by mass of 18 crown 6-ether (manufactured by Tokyo Chemical Industry Co., Ltd.) were added to the resulting mixture, and the mixture was preheated to a temperature of 100° C., and then stirred for 2 minutes under the conditions of a speed of 800 rpm and a revolution speed of 1600 rpm using the rotation-revolution type vacuum defoaming mixer.

To this mixture, 8.83 parts by mass of polyhydrogenmethylsiloxane (trade name: HMS-151, manufactured by ASMAX Corporation) was added, and the mixture was stirred for 2 min under conditions of a speed of 800 rpm and a revolution speed of 1,600 rpm using the rotation-revolution type vacuum defoaming mixer.

The resulting mixture was injected into a mold spaced at an interval of 1 mm over 10 seconds and then heated at a temperature of 130° C. for 2 hours, and the mixture was cured. Subsequently, the cured product was demolded from the mold, and further aged at a temperature of 200° C. for 2 hours to form a sheet-shaped silicone molded dielectric layer having a size of 5 cm square and a thickness of 1 mm. The resulting silicone molded dielectric layer was evaluated in the same manner as in Example 1.

The evaluation results of Examples 1 to 32 and Comparative Examples 1 to 3 are shown in Tables 6-1 to 6-3.

TABLE 6-1

| | Evaluation 1 | Evaluation 2 | | |
|---|---|---|---|---|
| | Confirmation and | Relative | Evaluation 3 | Evaluation 4 |
| | analysis of | dielectric | Microrubber | Strain |
| | matrix and domains | constant | hardness | (μm) |
| Example 1 | M: Structure derived from | 10.0 | 55 | 0.30 |
| | polycarbonate urethane | | | |
| | D: None | | | |
| Example 2 | M: Structure derived from | 10.0 | 55 | 0.30 |
| | polyester urethane | | | |
| | D: None | | | |
| Example 3 | M: Structure derived from | 15.0 | 55 | 0.30 |
| | polycarbonate urethane | | | |
| | D: None | | | |
| Example 4 | M: Structure derived from | 15.0 | 55 | 0.30 |
| | polyester urethane | | | |
| | D: None | | | |
| Example 5 | M: Structure derived from | 8.0 | 55 | 0.30 |
| | polycarbonate urethane | | | |
| | D: None | | | |
| Example 6 | M: Structure derived from | 10.0 | 55 | 0.30 |
| | polycarbonate urethane | | | |
| | D: None | | | |
| Example 7 | M: Structure derived from | 8.0 | 55 | 0.30 |
| | polycarbonate urethane | | | |
| | D: None | | | |
| Example 8 | M: Structure derived from | 8.0 | 55 | 0.30 |
| | polycarbonate urethane | | | |
| | D: None | | | |
| Example 9 | M: Structure derived from | 10.0 | 55 | 0.30 |
| | polycarbonate urethane | | | |
| | D: None | | | |
| Example 10 | M: Structure derived from | 10.0 | 55 | 0.30 |
| | polycarbonate urethane | | | |
| | D: None | | | |
| Example 11 | M: Structure derived from | 10.0 | 55 | 0.30 |
| | polycarbonate urethane | | | |
| | D: None | | | |
| Example 12 | M: Structure derived from | 10.0 | 55 | 0.30 |
| | polycarbonate urethane | | | |
| | D: None | | | |
| Example 13 | M: Structure derived from | 10.0 | 55 | 0.30 |
| | polycarbonate urethane | | | |
| | D: None | | | |
| Example 14 | M: Structure derived from | 10.0 | 55 | 0.30 |
| | polycarbonate urethane | | | |
| | D: None | | | |

TABLE 6-2

| | Evaluation 1 | Evaluation 2 | | | | | Evaluation 6 | Evaluation 7 |
|---|---|---|---|---|---|---|---|---|
| | Confirmation and | Relative | Evaluation 3 | Evaluation 4 | Evaluation 5 | | Area | Average |
| | analysis of matrix | dielectric | Microrubber | Strain | Parameter | Parameter | ratio of | circularity |
| | and domains | constant | hardness | (μm) | A (mV) | B (mV) | domains (%) | of domains |
| Example | M: Structure derived from | 20.0 | 30 | 0.50 | 80 | 210 | 30 | 0.95 |
| 15 | polycarbonate urethane | | | | | | | |
| | D: Structure derived from | | | | | | | |
| | polyether | | | | | | | |
| Example | M: Structure derived from | 20.0 | 30 | 0.50 | 80 | 210 | 30 | 0.95 |
| 16 | polycarbonate urethane | | | | | | | |
| | D: Structure derived from | | | | | | | |
| | polyether | | | | | | | |
| Example | M: Structure derived from | 30.0 | 30 | 0.50 | 80 | 210 | 30 | 0.95 |
| 17 | polycarbonate urethane | | | | | | | |
| | D: Structure derived from | | | | | | | |
| | polyether | | | | | | | |
| Example | M: Structure derived from | 16.0 | 30 | 0.50 | 80 | 210 | 30 | 0.95 |
| 18 | polycarbonate urethane | | | | | | | |
| | D: Structure derived from | | | | | | | |
| | polyether | | | | | | | |
| Example | M: Structure derived from | 20.0 | 30 | 0.50 | 80 | 210 | 30 | 0.95 |
| 19 | polycarbonate urethane | | | | | | | |
| | D: Structure derived from | | | | | | | |
| | polyether | | | | | | | |
| Example | M: Structure derived from | 16.0 | 30 | 0.50 | 80 | 210 | 30 | 0.95 |
| 20 | polycarbonate urethane | | | | | | | |
| | D: Structure derived from | | | | | | | |
| | polyether | | | | | | | |
| Example | M: Structure derived from | 16.0 | 30 | 0.50 | 80 | 210 | 30 | 0.95 |
| 21 | polycarbonate urethane | | | | | | | |
| | D: Structure derived from | | | | | | | |
| | polyether | | | | | | | |
| Example | M: Structure derived from | 20.0 | 30 | 0.50 | 80 | 210 | 30 | 0.95 |
| 22 | polycarbonate urethane | | | | | | | |
| | D: Structure derived from | | | | | | | |
| | polyether | | | | | | | |
| Example | M: Structure derived from | 20.0 | 30 | 0.50 | 80 | 210 | 30 | 0.95 |
| 23 | polycarbonate urethane | | | | | | | |
| | D: Structure derived from | | | | | | | |
| | polyether | | | | | | | |
| Example | M: Structure derived from | 20.0 | 30 | 0.50 | 80 | 210 | 30 | 0.95 |
| 24 | polycarbonate urethane | | | | | | | |
| | D: Structure derived from | | | | | | | |
| | polyether | | | | | | | |
| Example | M: Structure derived from | 20.0 | 30 | 0.50 | 80 | 210 | 30 | 0.95 |
| 25 | polycarbonate urethane | | | | | | | |
| | D: Structure derived from | | | | | | | |
| | polyether | | | | | | | |
| Example | M: Structure derived from | 20.0 | 30 | 0.50 | 80 | 210 | 30 | 0.95 |
| 26 | polycarbonate urethane | | | | | | | |
| | D: Structure derived from | | | | | | | |
| | polyether | | | | | | | |
| Example | M: Structure derived from | 20.0 | 30 | 0.50 | 80 | 210 | 30 | 0.95 |
| 27 | polycarbonate urethane | | | | | | | |
| | D: Structure derived from | | | | | | | |
| | polyether | | | | | | | |
| Example | M: Structure derived from | 20.0 | 30 | 0.50 | 85 | 210 | 30 | 0.95 |
| 28 | polycarbonate urethane | | | | | | | |
| | D: Structure derived from | | | | | | | |
| | polyether | | | | | | | |
| Example | M: Structure derived from | 20.0 | 20 | 1.00 | 80 | 130 | 30 | 0.95 |
| 29 | polycarbonate urethane | | | | | | | |
| | D: Structure derived from | | | | | | | |
| | polyether | | | | | | | |
| Example | M: Structure derived from | 40.0 | 20 | 1.00 | 40 | 130 | 50 | 0.95 |
| 30 | polyester urethane | | | | | | | |
| | D: Structure derived from | | | | | | | |
| | polyether | | | | | | | |
| Example | M: Structure derived from | 10.0 | 50 | 0.03 | 140 | 310 | 10 | 0.95 |
| 31 | polycarbonate urethane | | | | | | | |
| | D: Structure derived from | | | | | | | |
| | polyether | | | | | | | |
| Example | M: Structure derived from | 20.0 | 30 | 0.50 | 80 | 210 | 30 | 0.60 |
| 32 | polycarbonate urethane | | | | | | | |
| | D: Structure derived from | | | | | | | |
| | polyether | | | | | | | |

TABLE 6-3

| | Evaluation 1 | Evaluation 2 | | |
|---|---|---|---|---|
| | Confirmation and | Relative | Evaluation 3 | Evaluation 4 |
| | analysis of | dielectric | Microrubber | Strain |
| | matrix and domains | constant | hardness | (μm) |
| Comparative | M: Structure derived from | 6.0 | 55 | 0.30 |
| Example 1 | polycarbonate urethane | | | |
| | D: None | | | |
| Comparative | M: Structure derived from | 3.0 | 55 | 0.30 |
| Example 2 | polycarbonate urethane | | | |
| | D: None | | | |
| Comparative | M: Structure derived from | 3.0 | 40 | 0.03 |
| Example 3 | silicone | | | |
| | D: None | | | |

In Tables 6-1 to 6-3, M represents a matrix and D represents a domain.

The dielectric layers according to Examples 1 to 14 had a high relative dielectric constant at a frequency of 1 kHz, and had flexibility as an elastomer maintained, because a hard filler such as barium titanate was not blended.

In the dielectric layers according to Examples 15 to 32, a plurality of domains was dispersed in the matrix containing the urethane elastomer, and the parameter B indicating the viscoelastic term of the matrix was larger than the parameter A indicating the viscoelastic term of each of the domains. As a result, the dielectric layers according to Examples 15 to 32 became more flexible than the dielectric layers according to Examples 1 to 14, and also had excellent recoverability against deformation. Also, the dielectric layers according to Examples 15 to 32 had a higher relative dielectric constant at a frequency of 1 kHz than that of the dielectric layers according to Examples 1 to 14 due to the structure from the polyether of the domains.

Meanwhile, in the dielectric layer according to Comparative Example 1, it is considered that the molecular mobility of the ionic liquid was reduced by the interaction with the urethane bond. However, it is considered that the dielectric layer according to Comparative Example 1 contained no cyclic multidentate ligand, so the distance between the ion pairs of the ionic liquid was not sufficiently large, resulting in a low relative dielectric constant at a frequency of 1 kHz.

Also, since the dielectric layer according to Comparative Example 2 contained no ionic liquid, polarization between the ion pairs of the ionic liquid did not occur in the first place, and the relative dielectric constant at a frequency of 1 kHz was low.

It is considered that the silicone molded dielectric layer according to Comparative Example 3 contains both the ionic liquid and the cyclic multidentate ligand, but it is not possible to reduce the molecular mobility of the ionic liquid due to the absence of a urethane bond. As a result, it was not possible to allow the cyclic multidentate ligand to coordinate to the cation of the ionic liquid, resulting in a low relative dielectric constant at a frequency of 1 kHz.

From the above evaluation results, it has become clear that the dielectric layer according to the present disclosure has both high dielectric properties and flexibility, and is suitable as a dielectric layer for a transducer or the like.

While the present invention has been described with reference to exemplary embodiments, it is to be understood that the invention is not limited to the disclosed exemplary embodiments. The scope of the following claims is to be accorded the broadest interpretation so as to encompass all such modification and equivalent structures and functions.

This application claims the benefit of Japanese Patent Application No. 2024-069689 filed on Apr. 23, 2024, and Japanese Patent Application No. 2024-215076 filed on Dec. 10, 2024, which are hereby incorporated by reference herein in their entirety.

What is claimed is:

1. A transducer capable of converting from mechanical energy to electrical energy and/or from electrical energy to mechanical energy,
the transducer comprising a dielectric layer,
wherein a relative dielectric constant of the dielectric layer at a frequency of 1 kHz is at least 8.0, and
the dielectric layer satisfies any of conditions (i) to (vi) below:
(i) the dielectric layer comprises a urethane elastomer, an ionic liquid, and a cyclic multidentate ligand;
(ii) the dielectric layer comprises a urethane elastomer, a cyclic multidentate ligand, and an anion, and the urethane elastomer has a cationic structure in a molecule;
(iii) the dielectric layer comprises a urethane elastomer, a cyclic multidentate ligand, and a cation, and the urethane elastomer has an anionic structure in a molecule;
(iv) the dielectric layer comprises a urethane elastomer and an ionic liquid, and the urethane elastomer has a structure of a cyclic multidentate ligand in a molecule;
(v) the dielectric layer comprises a urethane elastomer and an anion, and the urethane elastomer has a structure of a cyclic multidentate ligand and a cationic structure in a molecule; and
(vi) the dielectric layer comprises a urethane elastomer and a cation, and the urethane elastomer comprises a structure of a cyclic multidentate ligand and an anionic structure in a molecule.

2. The transducer according to claim 1, wherein the dielectric layer satisfies the condition (i).

3. The transducer according to claim 1, wherein the dielectric layer satisfies the condition (ii).

4. The transducer according to claim 1, wherein the dielectric layer satisfies the condition (iii).

5. The transducer according to claim 1, wherein the dielectric layer satisfies the condition (iv).

6. The transducer according to claim 1, wherein the dielectric layer satisfies the condition (v).

7. The transducer according to claim 1, wherein the dielectric layer satisfies the condition (vi).

8. The transducer according to claim 1, wherein the relative dielectric constant is at least 10.0.

9. The transducer according to claim 1, wherein the relative dielectric constant is at least 20.0.

10. The transducer according to claim 1, wherein the urethane elastomer comprises at least one selected from the group comprising polycarbonate urethane and polyester urethane.

11. The transducer according to claim 1, wherein the urethane elastomer comprises a matrix and domains dispersed in the matrix,
the matrix comprises at least one selected from the group comprising polycarbonate urethane and polyester urethane, and
the domains comprise a structure represented by Formula (1) below: 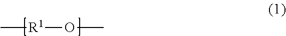
in Formula (1), R¹ represents a C3-C5 alkylene group.

12. The transducer according to claim 1, wherein the urethane elastomer comprises a matrix and domains dispersed in the matrix, and
a parameter A and a parameter B satisfy a relationship of A<B, where the parameter A indicates a viscoelastic term of each of the domains and the parameter B indicates a viscoelastic term of the matrix, the parameters A and B being measured in a viscoelastic image of a cross section in which the domains and the matrix are exposed with a scanning probe microscope.

13. The transducer according to claim 1, wherein the dielectric layer has a microrubber hardness of 20 to 50 degrees at a temperature of 23° C., and
in an indentation test using a nanoindenter on the dielectric layer at a temperature of 23° C., when a Vickers indenter is brought into contact with an outer surface of the dielectric layer, the Vickers indenter is indented at a loading speed of 10 mN/30 seconds and is maintained at a load of 10 mN for 60 seconds, followed by unloading, strain after 5 seconds from the unloading being not more than 1.00 μm.

14. The transducer according to claim 1, wherein the cyclic multidentate ligand comprises a structure represented by Formula (2) below: 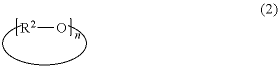
in Formula (2), n is an integer of 4 to 8, and R² represents a substituted or unsubstituted ethylene group or a substituted or unsubstituted phenylene group.

15. The transducer according to claim 1, wherein the cyclic multidentate ligand comprises a structure represented by Formula (3) below: 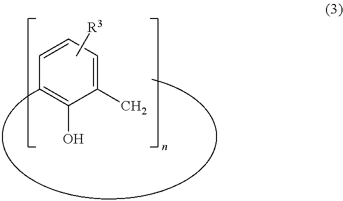
in Formula (3), n is an integer of 4 to 6, and R³ represents a hydrogen atom or an organic group.

16. The transducer according to claim 1, wherein the cyclic multidentate ligand comprises a structure represented by Formula (4) below: 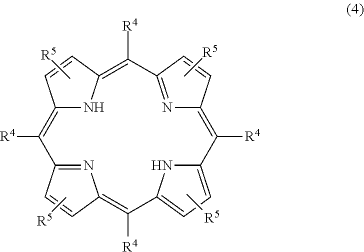
in Formula (4), R⁴ and R⁵ each independently represent a hydrogen atom or an organic group.

17. The transducer according to claim 1, wherein the transducer is a sensor, an actuator, or a power generating element.
